(19) United States
(12) Patent Application Publication
(10) Pub. No.: US 2023/0007348 A1
(43) Pub. Date: Jan. 5, 2023

(54) SYSTEMS AND METHODS FOR STREAMING WORKOUT VIDEO SESSIONS

(71) Applicant: BEACHBODY, LLC, El Segundo, CA (US)

(72) Inventors: Bryan Tyler Downing, Seattle, WA (US); Sheri Linn Green, Newbury Park, CA (US); Jese Emmanual Rodriquez, Santiago de los Caballeros (DO); Victor Hugo Afonso de Alencar, Sao Paulo (BR); Craig Mitchell, Oak Park, IL (US); Marty Henning, Santa Monica, CA (US)

(21) Appl. No.: 17/864,331

(22) Filed: Jul. 13, 2022

Related U.S. Application Data
(63) Continuation of application No. 17/747,683, filed on May 18, 2022.
(60) Provisional application No. 63/221,256, filed on Jul. 13, 2021.
(60) Provisional application No. 63/190,188, filed on May 18, 2021.

(51) Int. Cl. H04N 21/462; G06V 20/40; G06V 10/764; G06V 40/20; G06V 20/52; H04N 21/482; H04N 21/466

(52) U.S. Cl. CPC H04N 21/462; G06V 20/41; G06V 10/764; G06V 40/20; G06V 20/52; H04N 21/482; H04N 21/466

(57) ABSTRACT

Disclosed are example embodiments of systems and methods for displaying a workout session. For example, a method for displaying a workout session is disclosed. The method includes determining whether a plurality of participants are eligible to be presented on a wall of live streams of a live workout session. The method also includes displaying a video stream of a first participant from the plurality of participants on the wall of live streams based on the determination.

### CLAIM OF PRIORITY UNDER 35 U.S.C. § 119

The present Application for Patent claims priority to Provisional Application No. 63/221,256 entitled “SYSTEMS AND METHODS FOR STREAMING WORKOUT VIDEO SESSIONS” filed Jul. 13, 2021, and assigned to the assignee hereof and hereby expressly incorporated by reference herein. The present Application for Patent claims priority to Utility application Ser. No. 17/747,683 entitled “SYSTEMS AND METHODS FOR ORCHESTRATING WORKOUT VIDEO SESSIONS” filed May 18, 2022, and Provisional Application No. 63/190,188 entitled “SYSTEMS AND METHODS FOR ORCHESTRATING WORKOUT VIDEO SESSIONS” filed May 18, 2021, each of which is assigned to the assignee hereof and hereby expressly incorporated by reference herein.

### TECHNICAL FIELD

The disclosure relates generally to the field of exercise, and specifically and not by way of limitation; some embodiments are related to systems and methods for workout streaming.

### BACKGROUND

Many people begin fitness regimes only to abandon the effort later. Unfortunately, it can be difficult for many people to maintain the motivation to continue these fitness regimes. Work, children, spouses, schooling, and other activities may seem to get in the way of a person's fitness goals. However, fitness goals can be important to maintaining health and hopefully living a long life. Accordingly, the importance of working out cannot be understated. Thus, a need exists to help keep people motivated to continue the fitness routine to reach their goals and hopefully remain healthy and active. One way to help maintain motivation is to exercise within a workout community where members of that workout community may keep each other motivated.

### SUMMARY

In one example implementation, an embodiment includes systems and methods for displaying a workout session.

Disclosed are example embodiments of a method for displaying a workout session. The method includes determining whether a plurality of participants are eligible to be presented on a wall of live streams of a live workout session. The method also includes displaying a video stream of a first participant from the plurality of participants on the wall of live streams based on the determination.

Disclosed are example embodiments of a system for displaying a workout session with a virtual wall of live streams. The system may include one or more processors. The system may also include a memory coupled to the one or more processors. The memory has instructions that, when executed, cause the one or more processors to determine whether a plurality of participants are eligible to be presented on a wall of live streams of a live workout session and display a video stream of a first participant from the plurality of participants on the wall of live streams based on the determination.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary and the following detailed description are better understood when read in conjunction with the accompanying drawings. The accompanying drawings, which are incorporated herein and form part of the specification, illustrate a plurality of embodiments and, together with the description, further explain the principles involved and enable a person skilled in the relevant art(s) to make and use the disclosed technologies.

FIG. 1 is a diagram that illustrates the signup process for BODi using a QR code in accordance with the systems and methods described herein.

FIG. 2 is another diagram that illustrates the signup process for BODi using a QR code in accordance with the systems and methods described herein.

FIG. 3 is another diagram that illustrates the signup process for BODi using a QR code in accordance with the systems and methods described herein.

FIG. 4 is another diagram that illustrates the signup process for BODi using a QR code in accordance with the systems and methods described herein.

FIG. 5 is a diagram that illustrates a process for setting up a user profile in accordance with the systems and methods described herein.

FIG. 6 is another diagram that illustrates a process for setting up a user profile in accordance with the systems and methods described herein.

FIG. 7 is a diagram illustrating a tutorial process per the systems and methods described herein.

FIG. 8 is a diagram that illustrates a process for personalizing our heart rate zones in accordance with the systems and methods described herein.

FIG. 9 is a diagram that illustrates a welcome screen in accordance with the systems and methods described herein.

FIG. 10 is a diagram that illustrates a welcome screen in accordance with the systems and methods described herein.

FIG. 11 is a diagram that illustrates a plurality of available workout sessions in accordance with the systems and methods described herein.

FIG. 12 is a diagram that illustrates screenshots of a workout session in accordance with the systems and methods described herein.

FIG. 13 is a diagram that illustrates screenshots of a workout session in accordance with the systems and methods described herein.

FIG. 14 is a diagram that illustrates screenshots of a workout session in accordance with the systems and methods described herein.

FIG. 15 is a diagram that illustrates screenshots of a workout session in accordance with the systems and methods described herein.

FIG. 16 is a diagram that illustrates an after-workout session summary screen where the user can rate the workout session and view various workout statistics such as heart rate zones performance, calories burned, average speed, cadence, etc., in accordance with the systems and methods described herein.

FIG. 17 is a diagram that illustrates screenshots of programs or workout sessions available on the BODi platform in accordance with the systems and methods described herein.

FIG. 18 is another diagram that illustrates screenshots of programs or workout sessions available on the BODi platform in accordance with the systems and methods described herein.

FIG. 19 is another diagram that illustrates screenshots of programs or workout sessions available on the BODi platform in accordance with the systems and methods described herein.

FIG. 20 is a diagram that illustrates a purchasing option via QR code in accordance with the systems and methods described herein.

FIG. 21 is a diagram that illustrates screenshots of a workout session in accordance with the systems and methods described herein.

FIG. 22 is another diagram that illustrates screenshots of a workout session in accordance with the systems and methods described herein.

FIG. 23 is a diagram illustrating a virtual riding session in a virtual environment.

FIG. 24 is a diagram that illustrates a screenshot of an option to watch a video (e.g., a movie) during a workout session.

FIG. 25 is a diagram that illustrates screenshots of a workout schedule, which can be personalized to a user in accordance with the systems and methods described herein.

FIG. 26 is another diagram that illustrates screenshots of a workout schedule, which can be personalized to a user in accordance with the systems and methods described herein.

FIG. 27 is a diagram that illustrates screenshots of an interactive and live workout session and various embedded features of the interactive session in accordance with the systems and methods described herein.

FIG. 28 is another diagram that illustrates screenshots of an interactive and live workout session and various embedded features of the interactive session in accordance with the systems and methods described herein.

FIG. 29 is another diagram that illustrates screenshots of an interactive and live workout session and various embedded features of the interactive session in accordance with the systems and methods described herein.

FIG. 30 is another diagram that illustrates screenshots of an interactive and live workout session and various embedded features of the interactive session in accordance with the systems and methods described herein.

FIG. 31 is another diagram that illustrates screenshots of an interactive and live workout session and various embedded features of the interactive session in accordance with the systems and methods described herein.

FIG. 32 is a diagram that illustrates an after-workout session summary screen where the user can rate the workout session and also view various workout statistics such as heart rate zones performance, calories burned, average speed, cadence, etc., in accordance with the systems and methods described herein.

FIG. 33 is a diagram that illustrates screenshots of a process for searching for workout sessions or other informational videos on recipes, tips, etc., in accordance with the systems and methods described herein.

FIG. 34 is another diagram that illustrates screenshots of a process for searching for workout sessions or other informational videos on recipes, tips, etc., in accordance with the systems and methods described herein.

FIG. 35 is another diagram that illustrates screenshots of a process for searching for workout sessions or other informational videos on recipes, tips, etc., in accordance with the systems and methods described herein.

FIG. 36 is a diagram that illustrates a profile editing screen in accordance with the systems and methods described herein.

FIG. 37 is a diagram that illustrates BODi Class Flow in accordance with the systems and methods described herein.

FIG. 38 is a diagram that illustrates BODi Scheduler Client in accordance with the systems and methods described herein.

FIG. 39 is a diagram that illustrates BODi Scheduler Client, Class Creation in accordance with the systems and methods described herein.

FIG. 40 is a diagram that illustrates BODi Landing Page in accordance with the systems and methods described herein.

FIG. 41 is a diagram that illustrates BODi Class Schedule in accordance with the systems and methods described herein.

FIG. 42 is a diagram that illustrates BODi Class Detail in accordance with the systems and methods described herein.

FIG. 43 is a diagram that illustrates BODi Class Detail, Registered in accordance with the systems and methods described herein.

FIG. 44 is a diagram that illustrates BODi Class Detail, Registered for BODcast in accordance with the systems and methods described herein.

FIG. 45 is a diagram that illustrates BODi Class Registration Confirmation in accordance with the systems and methods described herein.

FIG. 46 is a diagram that illustrates BODi Class Cancelation Confirmation in accordance with the systems and methods described herein.

FIG. 47 is a diagram that illustrates BODi Studio Moderation Tool, Upcoming Class in accordance with the systems and methods described herein.

FIG. 48 is a diagram that illustrates BODi Studio Moderation Tool, Open Class in accordance with the systems and methods described herein.

FIG. 49 is a diagram that illustrates BODcast Class Lobby in accordance with the systems and methods described herein.

FIG. 50 is a diagram that illustrates BODcast Class Lobby 2 in accordance with the systems and methods described herein.

FIG. 51 is a diagram that illustrates BODcast Class Lobby 3 in accordance with the systems and methods described herein.

FIG. 52 is a diagram that illustrates BODi Live Class, BODcast Experience in accordance with the systems and methods described herein.

FIG. 53 is a diagram that illustrates BODi Studio Moderation Tool, Live Class in accordance with the systems and methods described herein.

FIG. 54 is a diagram that illustrates BODi Live Class Lobby, Participant Experience in accordance with the systems and methods described herein.

FIG. 55 is a diagram that illustrates BODi Live Class, Participant Experience in accordance with the systems and methods described herein.

FIG. 56 is a diagram that illustrates BODi Live Class, Participant Experience 2 in accordance with the systems and methods described herein.

FIG. 57 is a diagram that illustrates is a diagram that illustrates BODi Video on Demand Library in accordance with the systems and methods described herein.

FIG. 58 is a diagram that illustrates BODi On Demand Class Experience in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

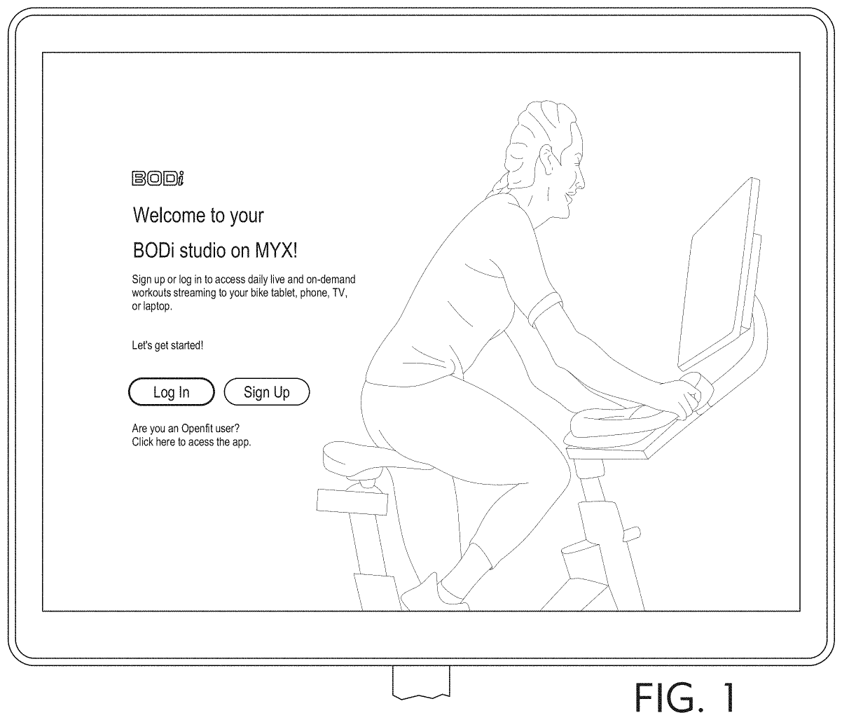

FIG. 1 is a diagram that illustrates the signup process for BODi using a QR code in accordance with the systems and methods described herein. More specifically, FIG. 1 illustrates a welcome screen for BODi. In an example embodiment, the welcome screen may be on a tablet connected to an exercise machine. For example, the tablet appears to be connected to a stationary bicycle in FIG. 1.

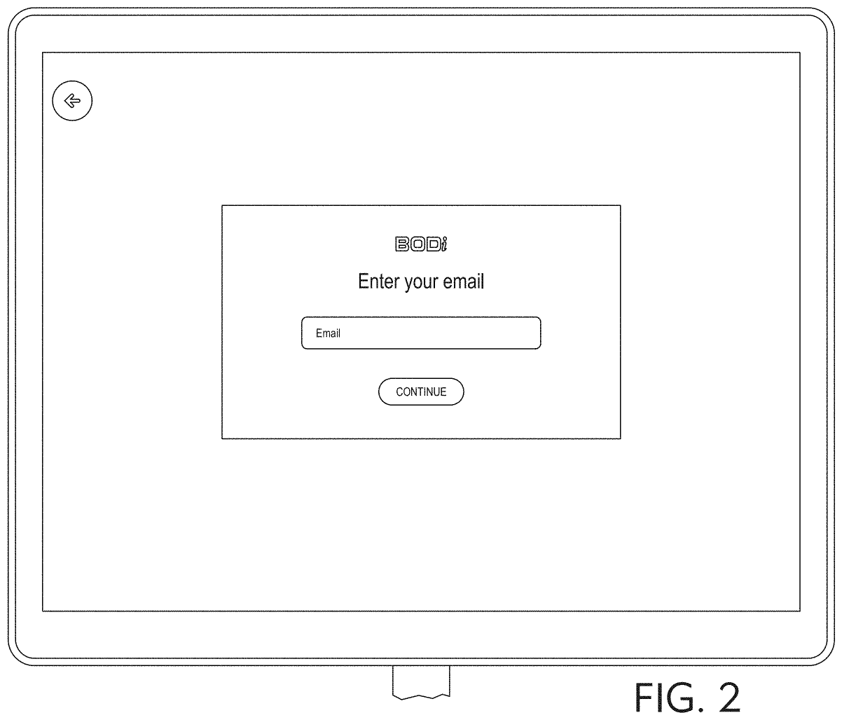

FIG. 2 is another diagram that illustrates the signup process for BODi using a QR code in accordance with the systems and methods described herein. The screen of FIG. 2 may allow a user to enter an e-mail. For example, to log in to an exercise account while on an exercise machine.

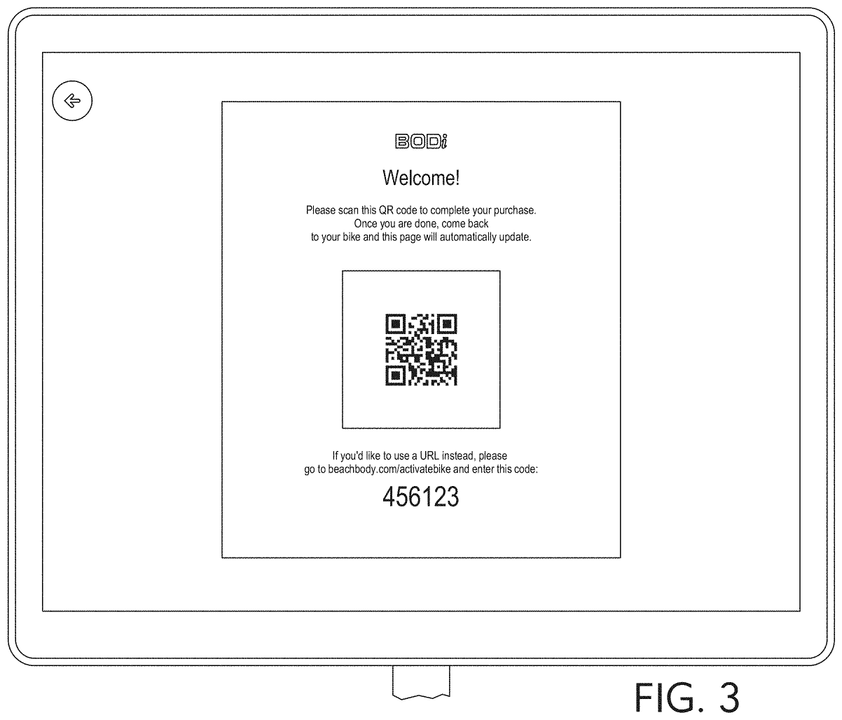

FIG. 3 is another diagram that illustrates the signup process for BODi using a QR code in accordance with the systems and methods described herein. The screen of FIG. 3 may be used to welcome a user. The welcome screen may include a QR code in an example embodiment.

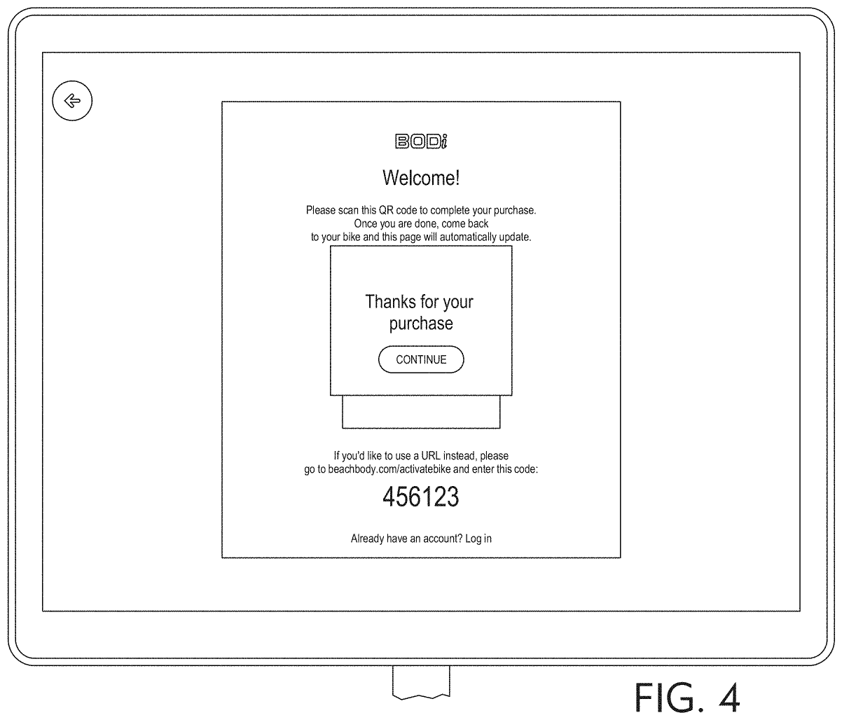

FIG. 4 is another diagram that illustrates the signup process for BODi using a QR code in accordance with the systems and methods described herein. More specifically, FIG. 4 illustrates a screen that may be used to thank a user for their purchase, e.g., of time using an exercise system in accordance with the systems and methods described herein.

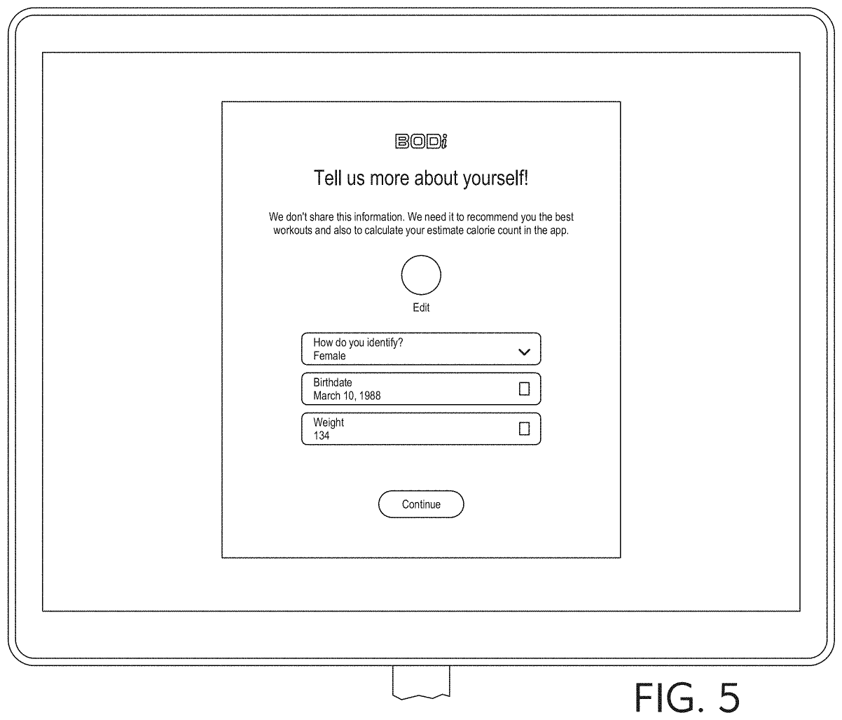

FIG. 5 is a diagram that illustrates a process for setting up a user profile in accordance with the systems and methods described herein. The example screen of FIG. 5 may allow users to enter more information about themselves. For example, such as spring may be used to enter demographic information.

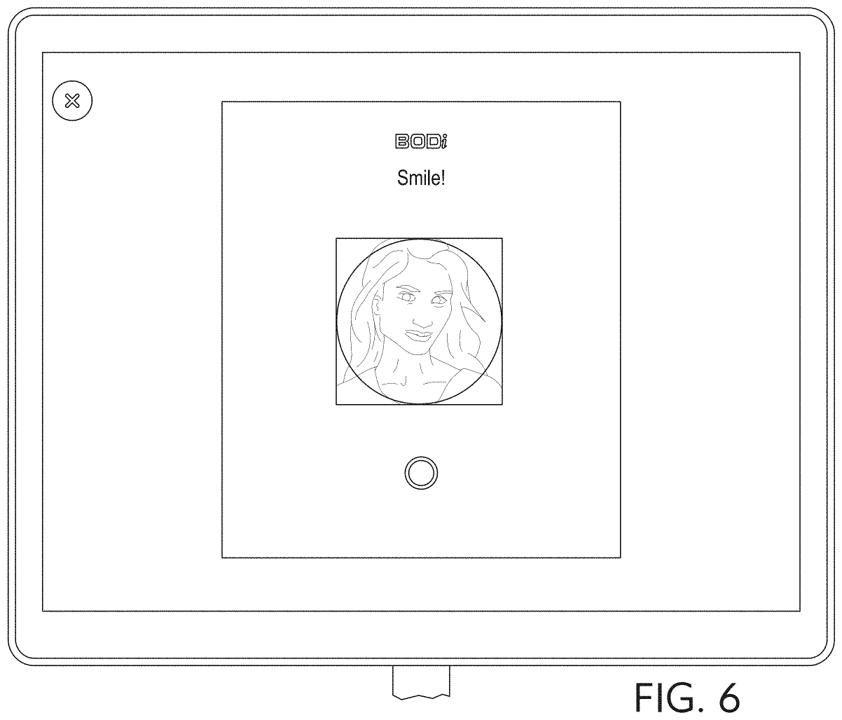

FIG. 6 is another diagram that illustrates a process for setting up a user profile in accordance with the systems and methods described herein. The screen illustrated in the figure may allow users to see their profile pictures and attempt to influence them to smile.

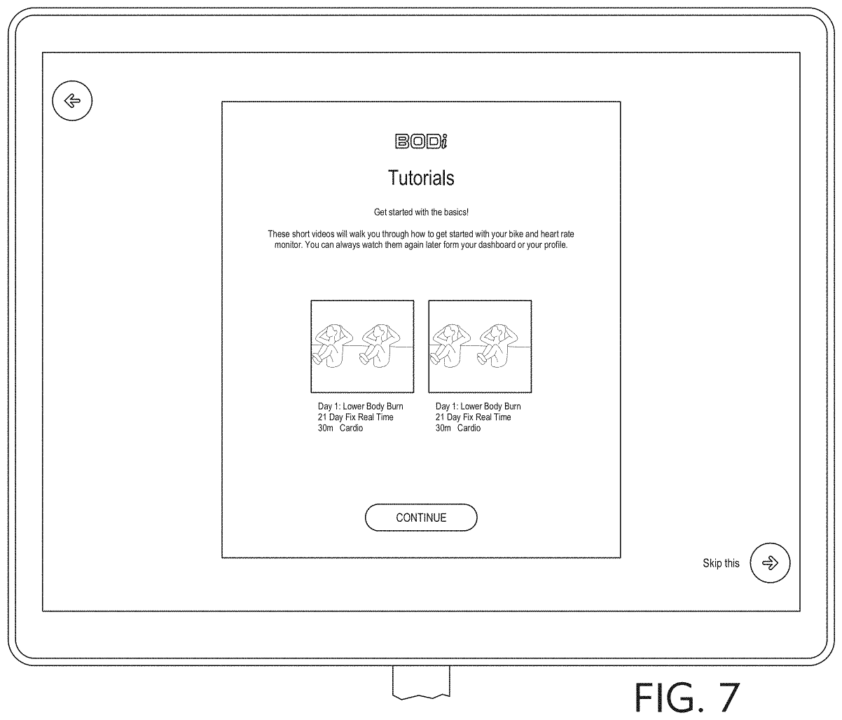

FIG. 7 is a diagram illustrating a tutorial process per the systems and methods described herein.

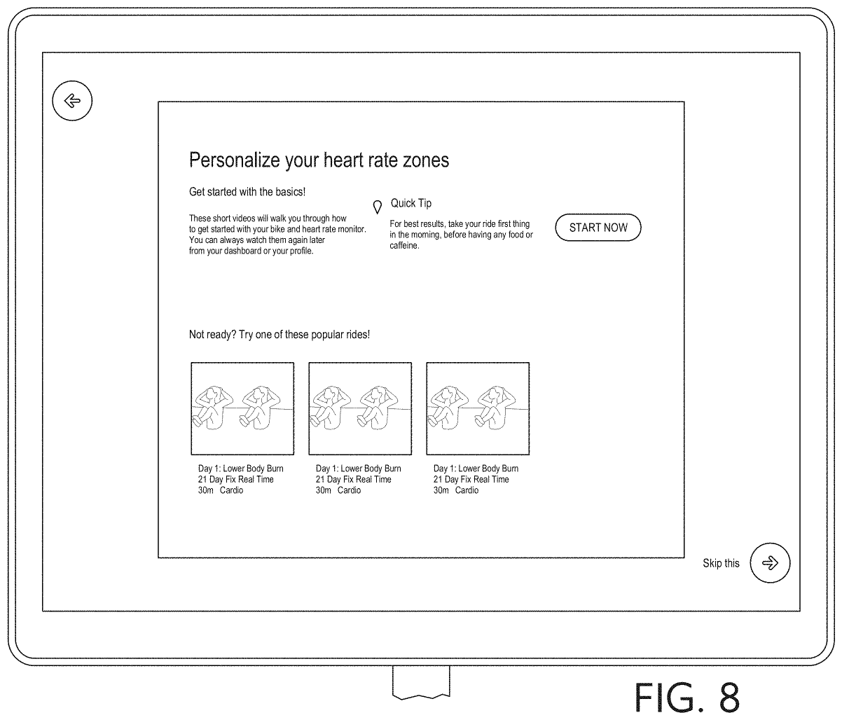

FIG. 8 is a diagram that illustrates a process for personalizing our heart rate zones in accordance with the systems and methods described herein.

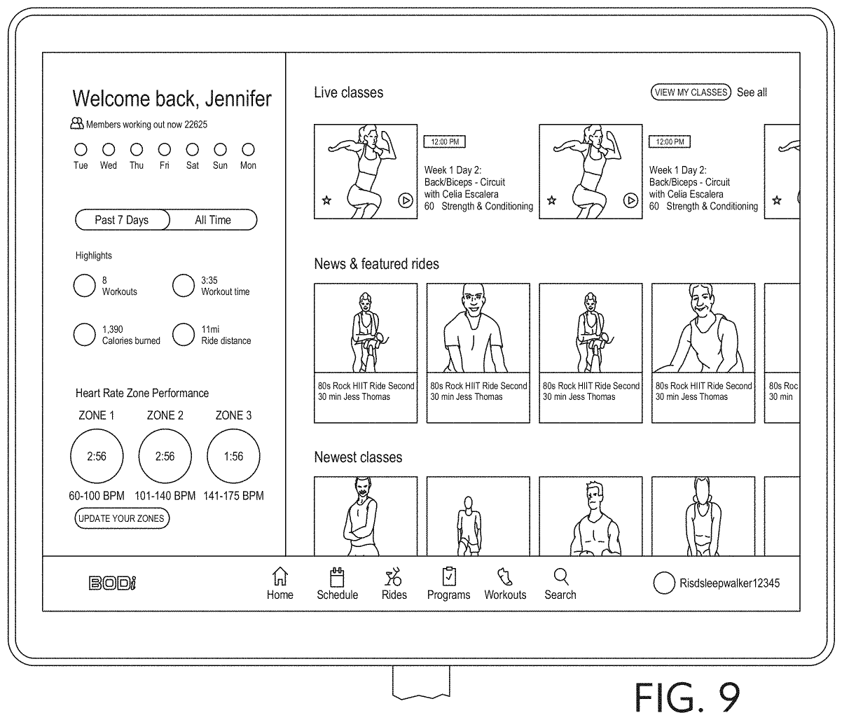

FIG. 9 is a diagram that illustrates a welcome screen in accordance with the systems and methods described herein.

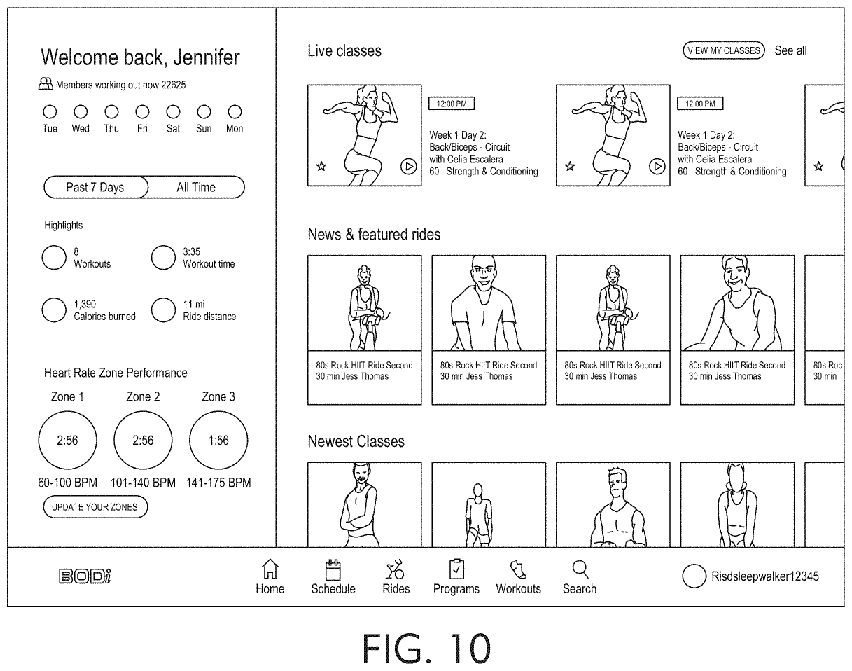

FIG. 10 is a diagram that illustrates a welcome screen in accordance with the systems and methods described herein.

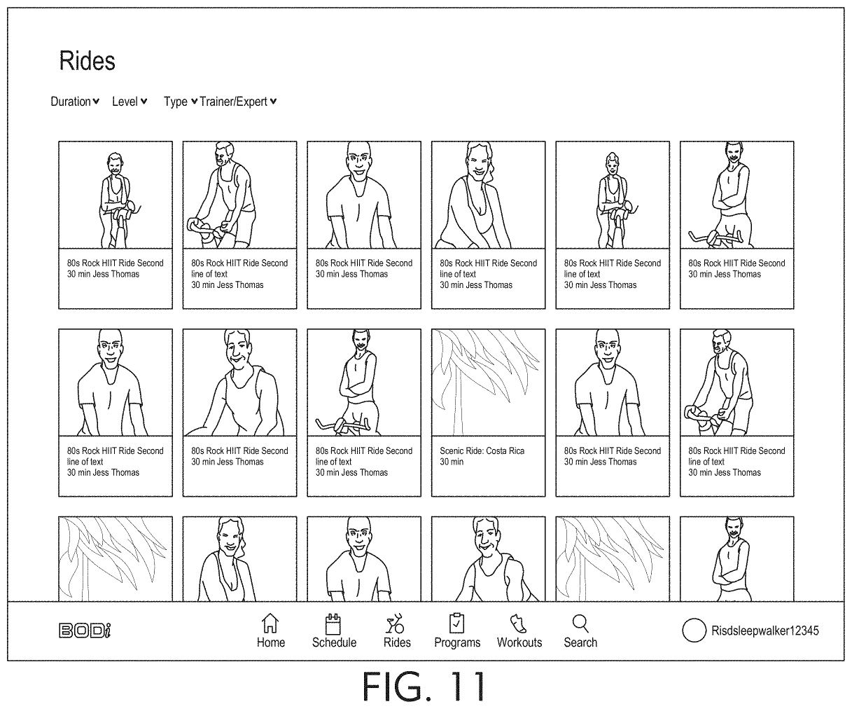

FIG. 11 is a diagram that illustrates a plurality of available workout sessions in accordance with the systems and methods described herein. (e.g., interactive live, live, on-demand). On-demand sessions can include live and previously recorded workout sessions.

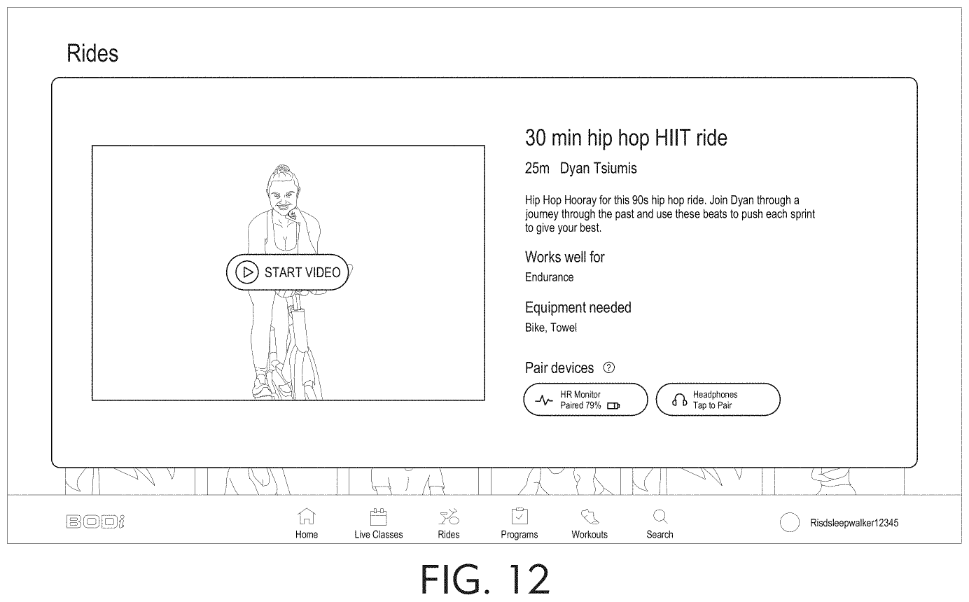

FIG. 12 is a diagram that illustrates screenshots of a workout session in accordance with the systems and methods described herein.

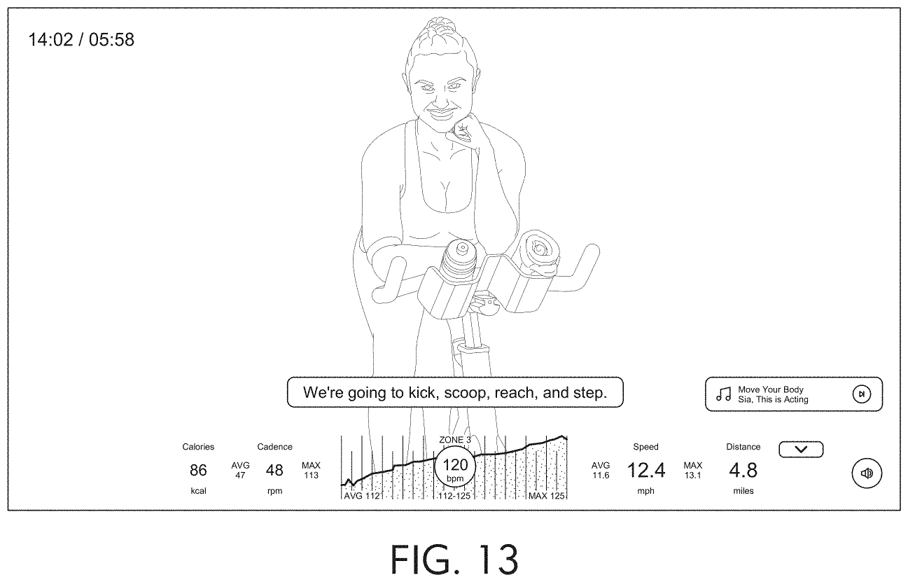

FIG. 13 is a diagram that illustrates screenshots of a workout session in accordance with the systems and methods described herein. The diagram illustrates an example of a trainer on an exercise bike. A great deal of information may be displayed on the screen, including a closed captioning of what the trainer is saying, a listing of any music that may be playing, and additional information. For example, the additional information may include calories burned during the exercise time cadence, exercise zone, speed, and distance.

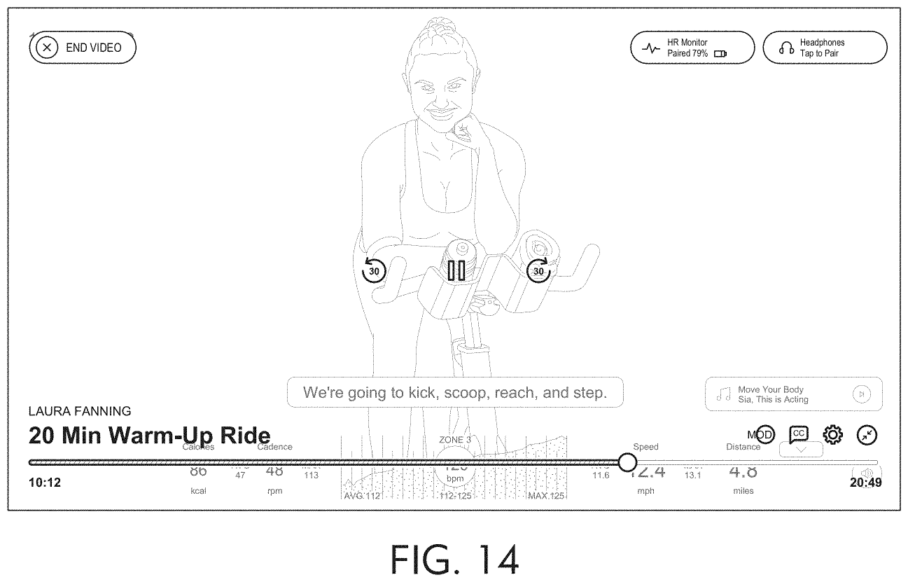

FIG. 14 is a diagram that illustrates screenshots of a workout session in accordance with the systems and methods described herein. The example illustrates a 20-minute warm-up ride. Additionally, a bar across the bottom of the screen illustrates progress through the 20-minute warm-up ride.

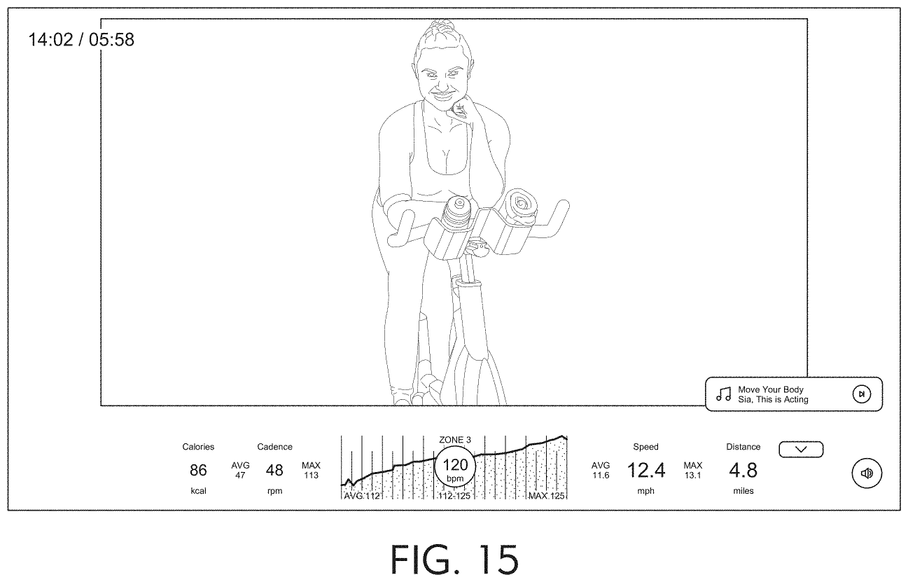

FIG. 15 is a diagram that illustrates screenshots of a workout session in accordance with the systems and methods described herein.

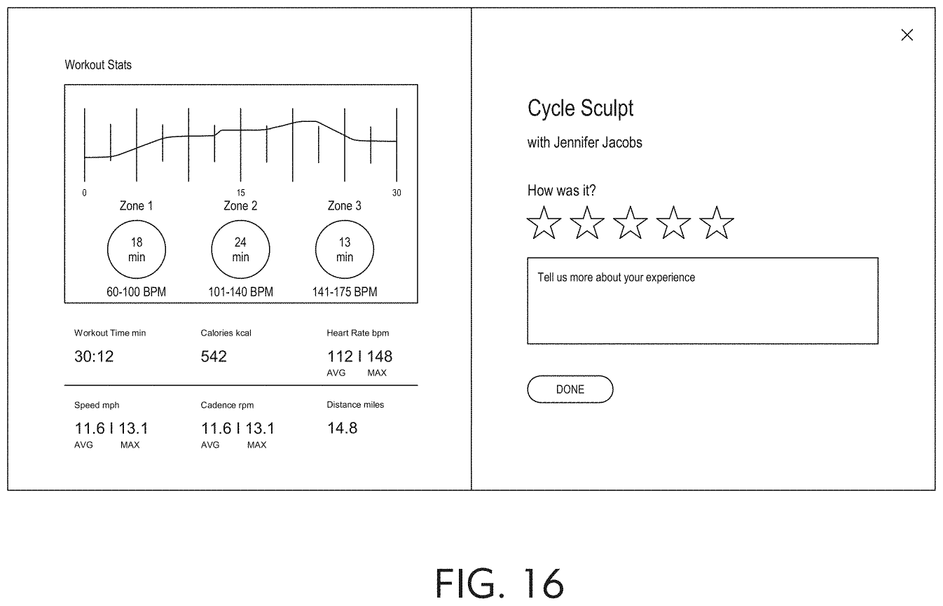

FIG. 16 is a diagram that illustrates an after-workout session summary screen where the user can rate the workout session and view various workout statistics such as heart rate zones performance, calories burned, average speed, cadence, etc., with the systems and methods described herein.

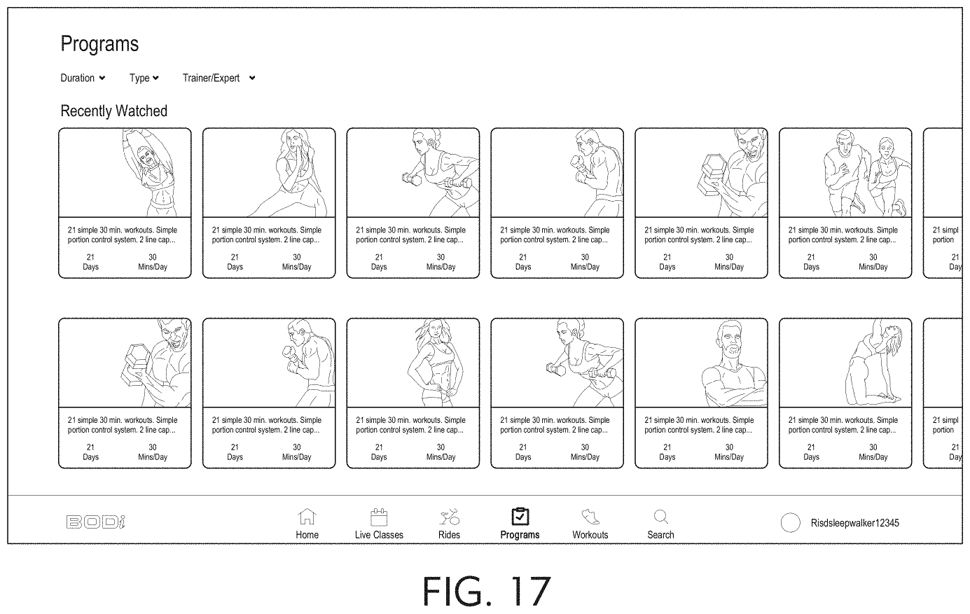

FIG. 17 is a diagram that illustrates screenshots of programs or workout sessions available on the BODi platform in accordance with the systems and methods described herein. As the diagram illustrates, many recently watched and new and featured programs may be illustrated.

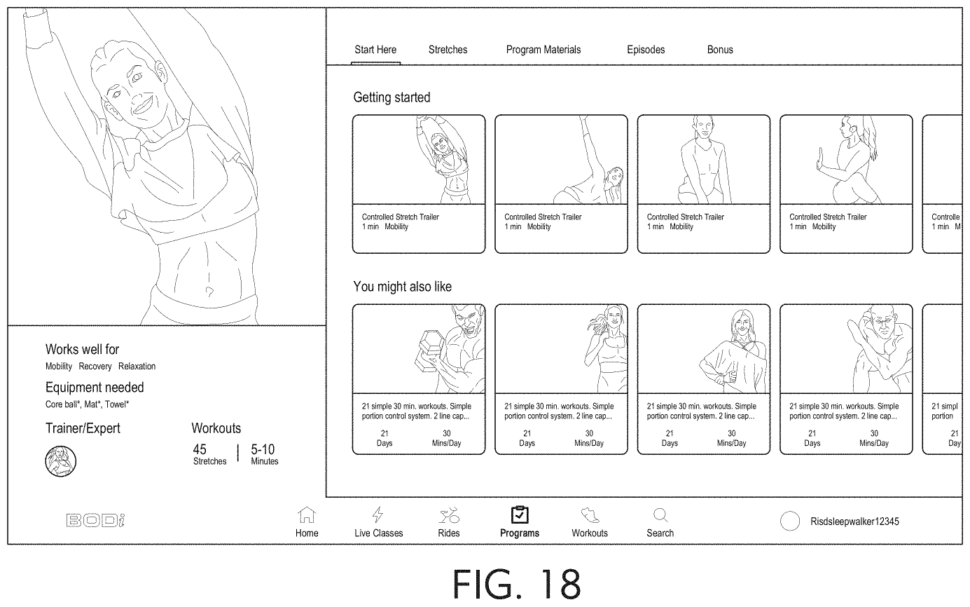

FIG. 18 is another diagram that illustrates screenshots of programs or workout sessions available on the BODi platform in accordance with the systems and methods described herein. The diagram illustrates several getting started videos and other videos that that particular user might like. For example, the diagram includes suggested videos that the user may like.

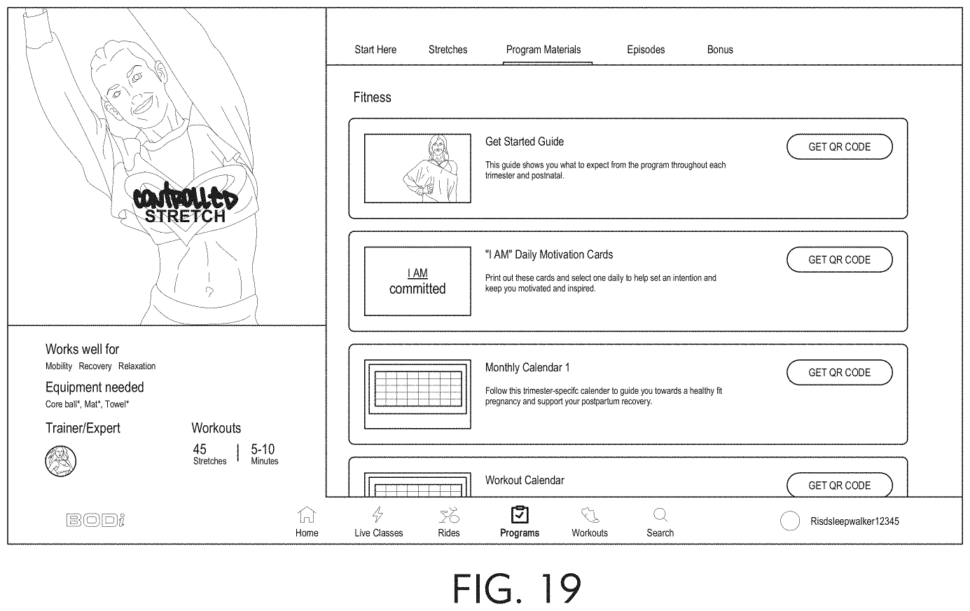

FIG. 19 is another diagram that illustrates screenshots of programs or workout sessions available on the BODi platform in accordance with the systems and methods described herein.

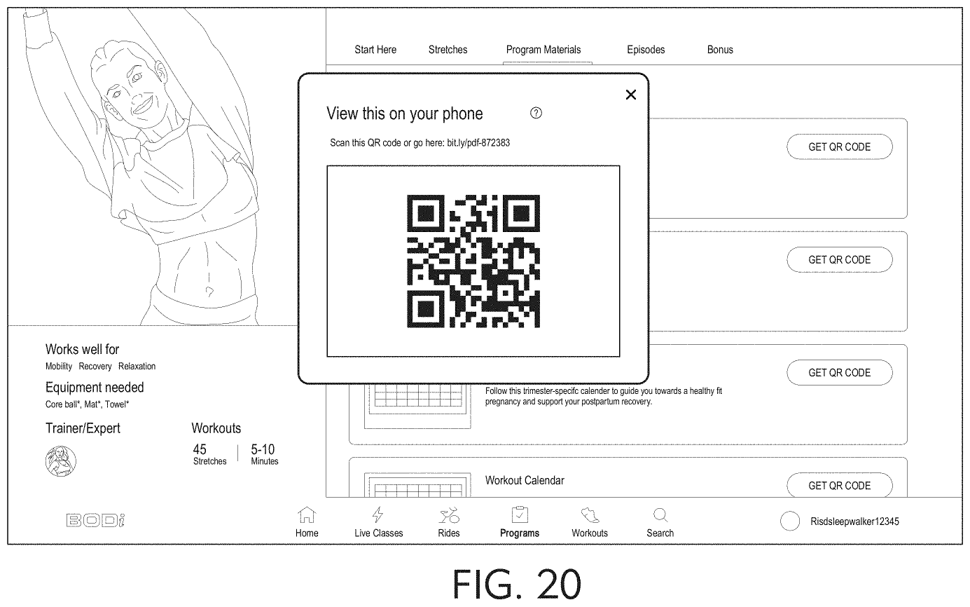

FIG. 20 is a diagram that illustrates a purchasing option via QR code in accordance with the systems and methods described herein.

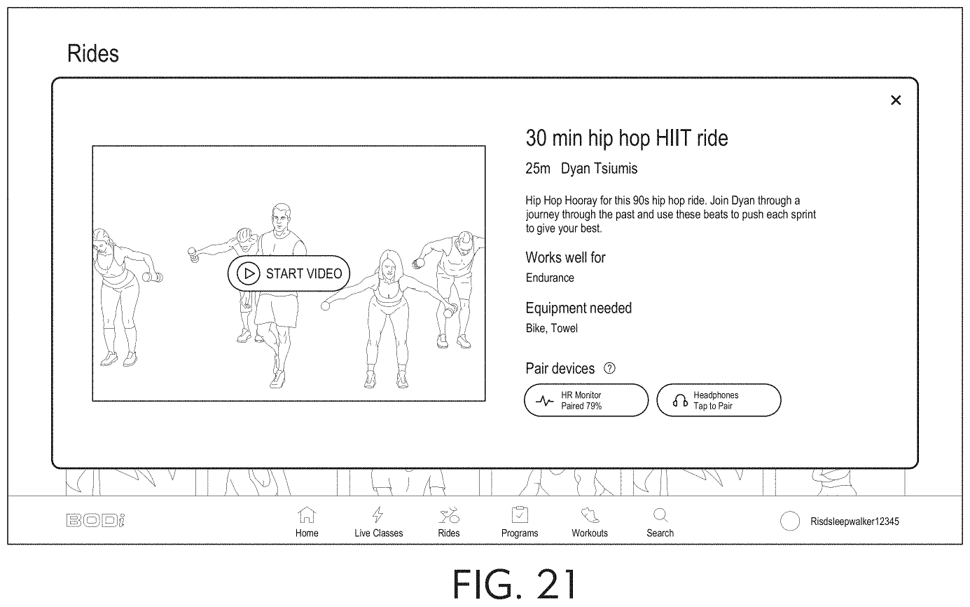

FIG. 21 is a diagram that illustrates screenshots of a workout session in accordance with the systems and methods described herein. The diagram illustrates a workout session for a day 47 core conditioning crusher. Various information on the workout is included. For example, the workout's length, the workout, the purpose of the workout, and the equipment needed Are all illustrated in the diagram. Additionally, pairing devices and buttons to pair are illustrated.

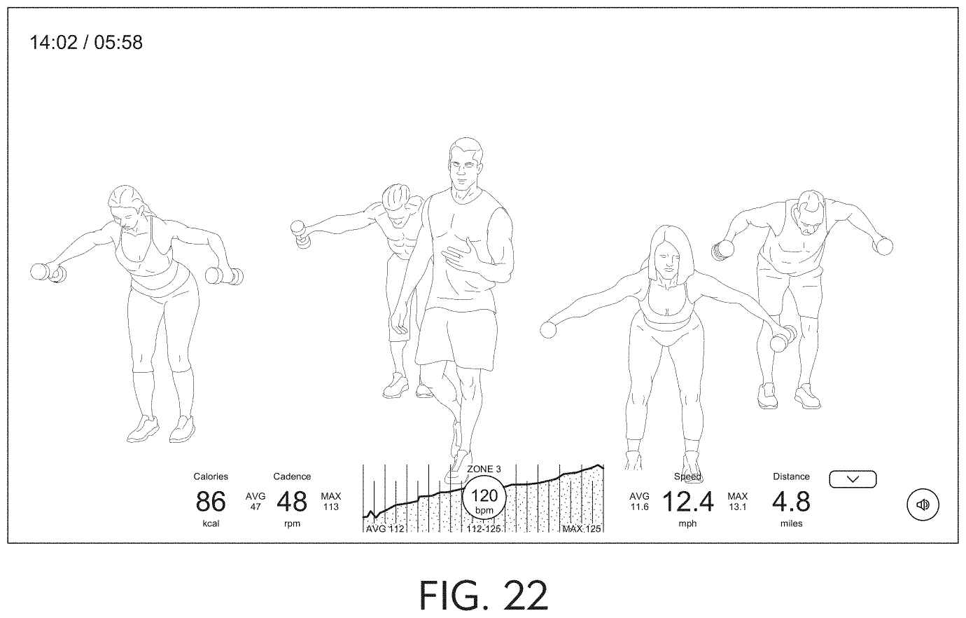

FIG. 22 is another diagram that illustrates screenshots of a workout session in accordance with the systems and methods described herein. The screenshot includes several people working out on video. Additionally, various data about the user may be provided at the bottom of the screen, such as calories burned and zone.

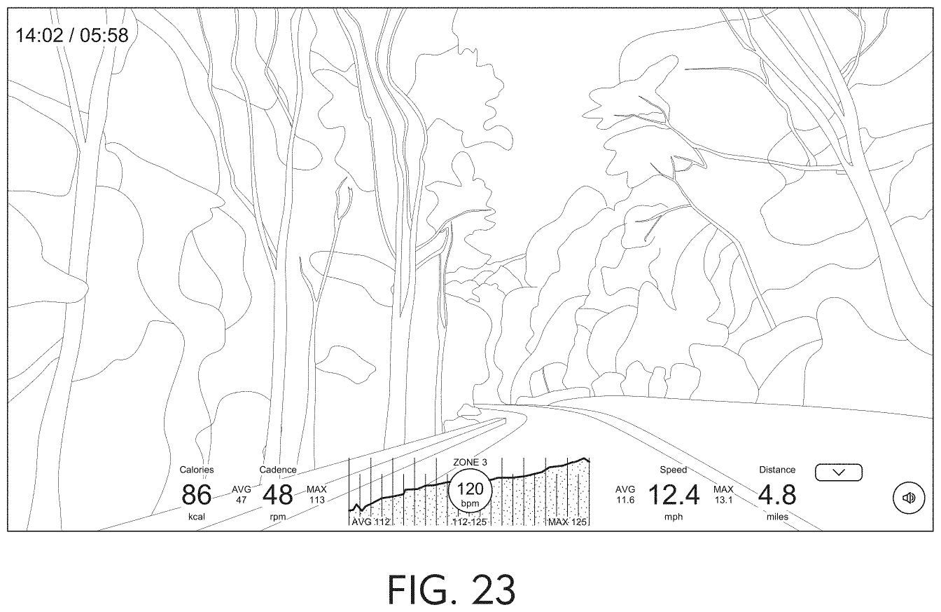

FIG. 23 is a diagram illustrating a virtual riding session in a virtual environment. The diagram shows a road through a wooded region. Accordingly, users may work out in a virtual environment, including that illustrated in the diagram. As discussed in other example embodiments, various information such as calories burned, cadence, speed, and distance may be illustrated at, for example, the bottom of the screen. It will be understood that this information may be presented in other locations on the screen.

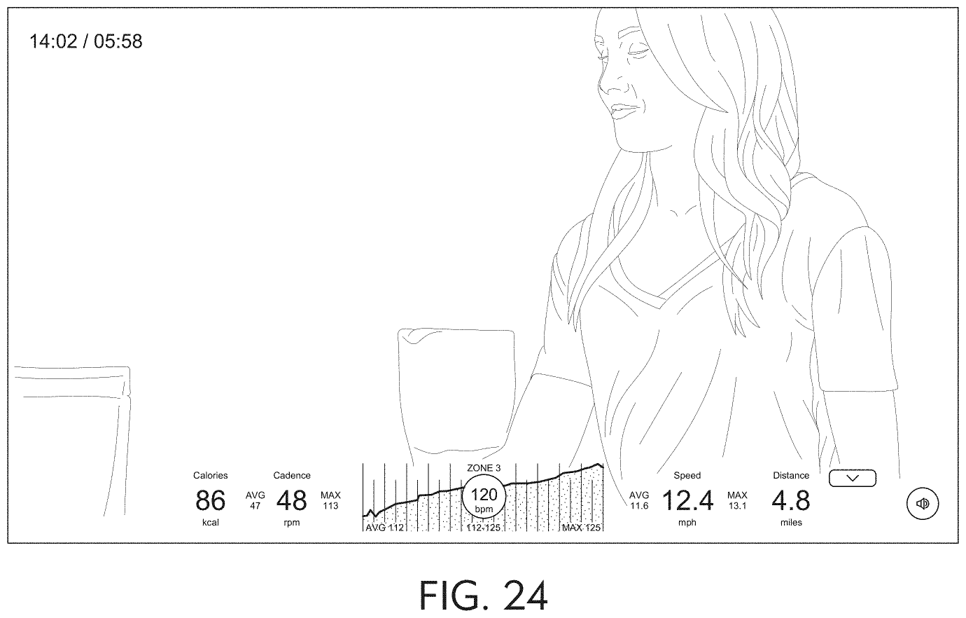

FIG. 24 is a diagram that illustrates a screenshot of an option to watch a video (e.g., a movie) during a workout session.

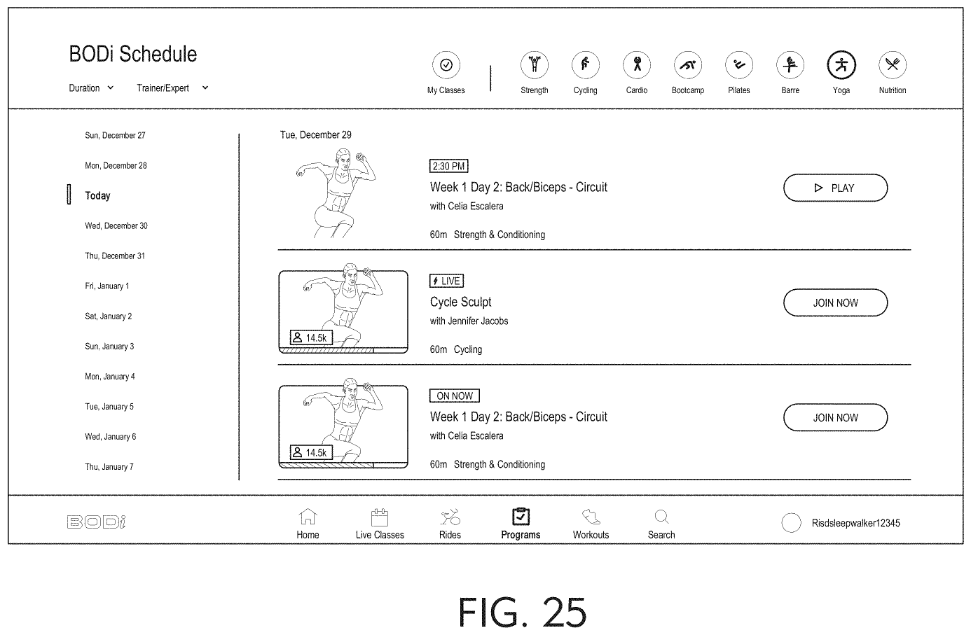

FIG. 25 is a diagram that illustrates screenshots of a workout schedule, which can be personalized to a user in accordance with the systems and methods described herein. The schedule may include several classes, including the date and time for the class as well as the title of the class and the trainer providing the class. The schedule in the example embodiment also illustrates the type I don't work out as well as the duration of the workout.

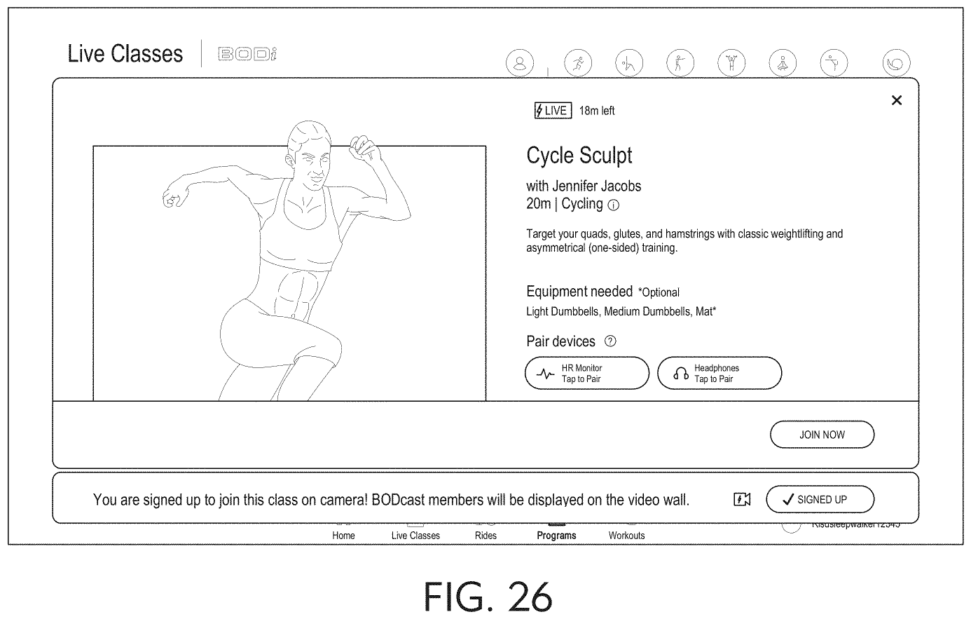

FIG. 26 is another diagram that illustrates screenshots of a workout schedule, which can be personalized to a user in accordance with the systems and methods described herein. The example illustrates a particular workout from the list of workouts. For example, “cycle sculpt” with Jennifer Jacobs is illustrated.

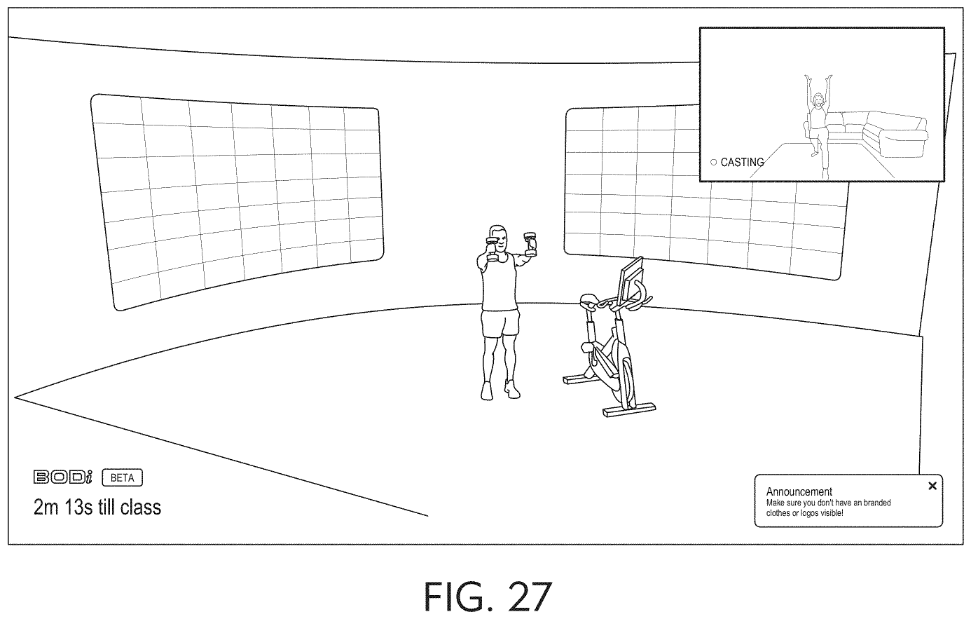

FIG. 27 is a diagram that illustrates screenshots of an interactive and live workout session and various embedded features of the interactive session in accordance with the systems and methods described herein. In some embodiments, the audio feed of a cast member can be highlighted (visually or by other means) to show other users the source of the audio. For example, referring to FIG. 27, the audio feed of the cast member displayed in the upper-right corner can be streamed or highlighted to other users.

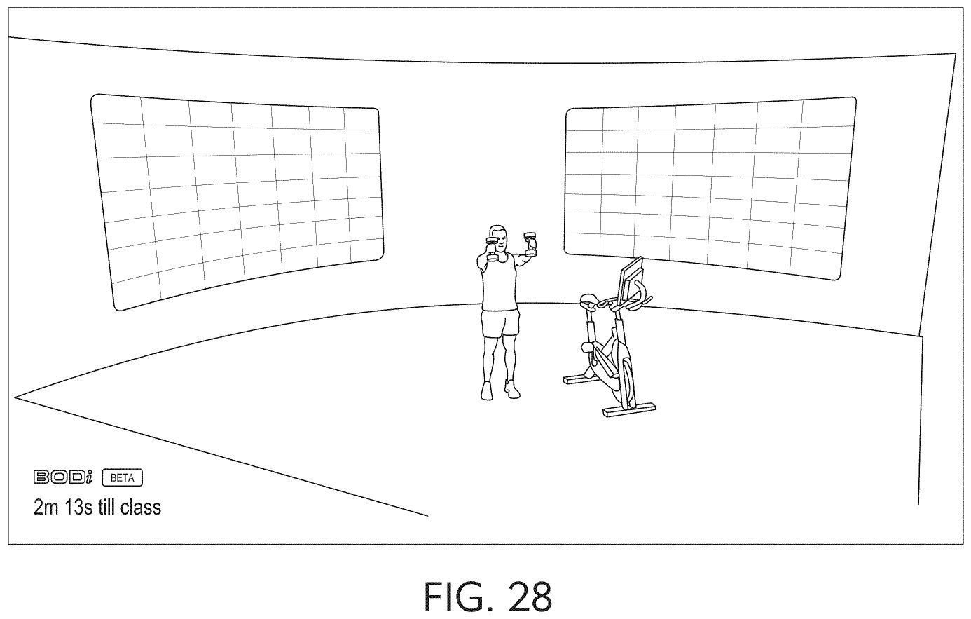

FIG. 28 is another diagram that illustrates screenshots of an interactive and live workout session and various embedded features of the interactive session in accordance with the systems and methods described herein. In some embodiments, the audio feed of a cast member can be highlighted (visually or by other means) to show other users the source of the audio. For example, referring to FIG. 27, the audio feed of the cast member displayed in the upper-right corner can be streamed or highlighted to other users.

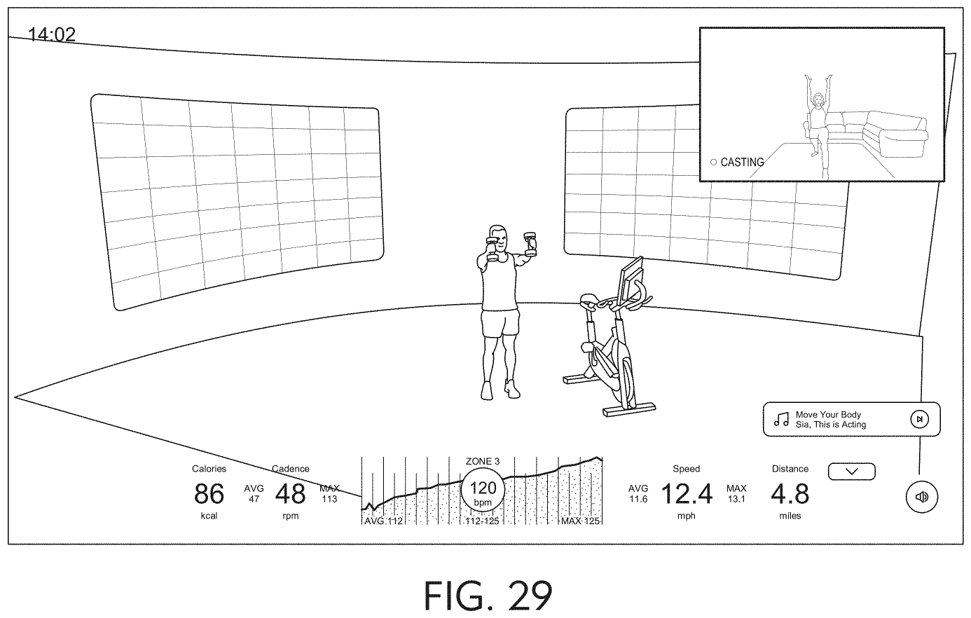

FIG. 29 is another diagram that illustrates screenshots of an interactive and live workout session and various embedded features of the interactive session in accordance with the systems and methods described herein. In some embodiments, the audio feed of a cast member can be highlighted (visually or by other means) to show other users the source of the audio. For example, referring to FIG. 27, the audio feed of the cast member displayed in the upper-right corner can be streamed or highlighted to other users.

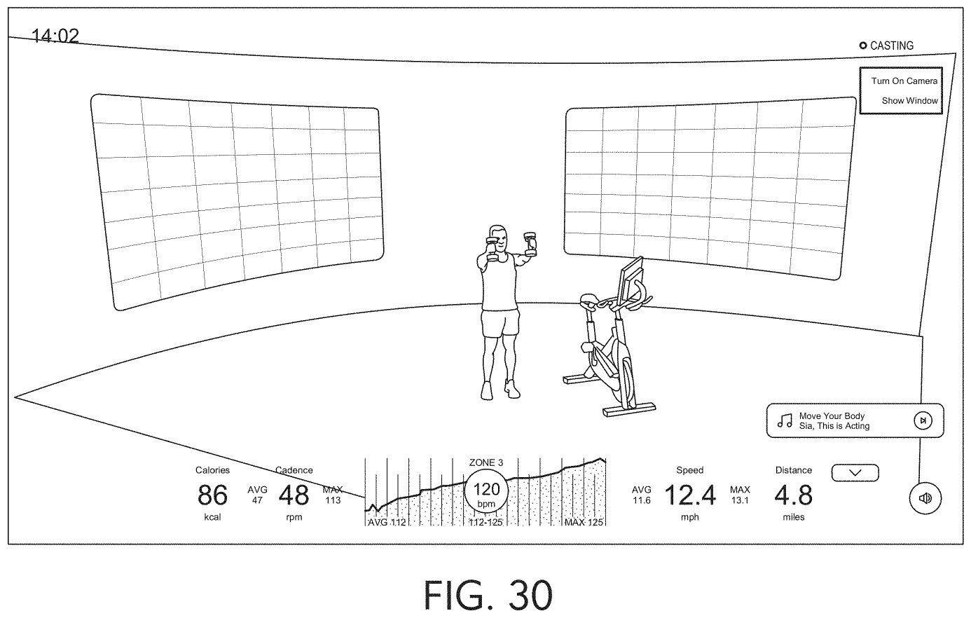

FIG. 30 is another diagram that illustrates screenshots of an interactive and live workout session and various embedded features of the interactive session in accordance with the systems and methods described herein. In some embodiments, the audio feed of a cast member can be highlighted (visually or by other means) to show other users the source of the audio. For example, referring to FIG. 27, the audio feed of the cast member displayed in the upper-right corner can be streamed or highlighted to other users.

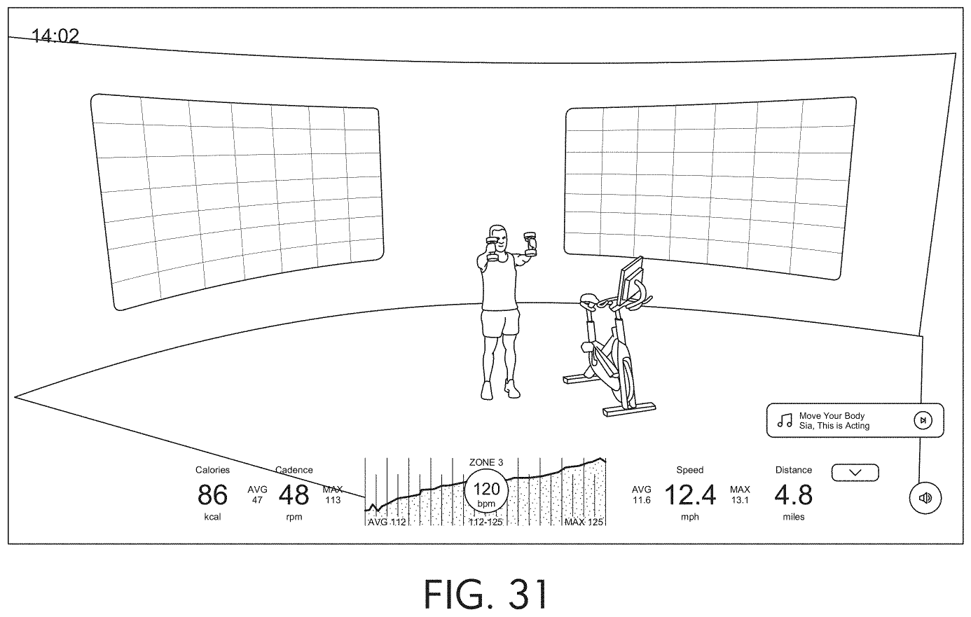

FIG. 31 is another diagram that illustrates screenshots of an interactive and live workout session and various embedded features of the interactive session in accordance with the systems and methods described herein. In some embodiments, the audio feed of a cast member can be highlighted (visually or by other means) to show other users the source of the audio. For example, referring to FIG. 27, the audio feed of the cast member displayed in the upper-right corner can be streamed or highlighted to other users.

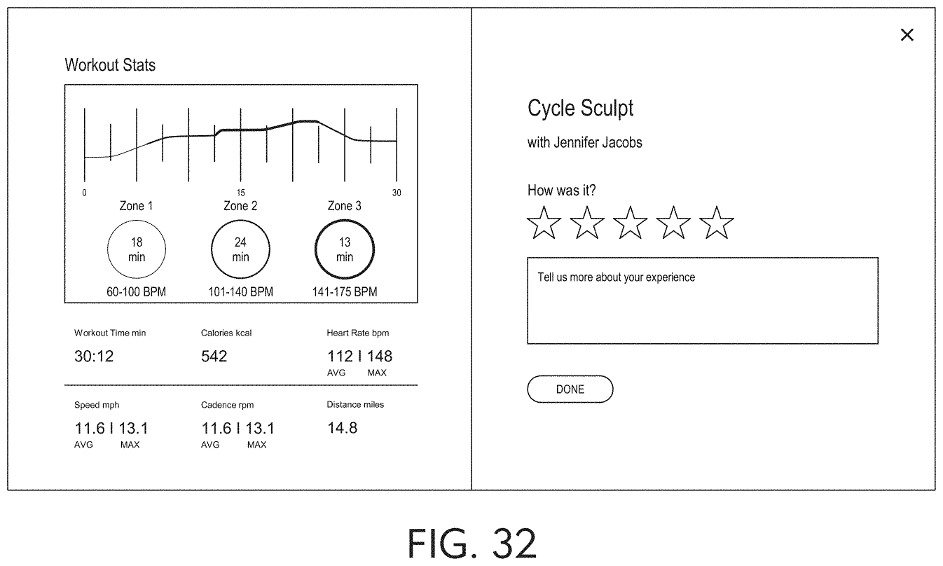

FIG. 32 is a diagram that illustrates an after-workout session summary screen where the user can rate the workout session and also view various workout statistics such as heart rate zones performance, calories burned, average speed, cadence, etc., in accordance with the systems and methods described herein. Additionally, FIG. 32 illustrates screenshots of a process for searching for workout sessions or other informational videos on recipes, tips, etc., in accordance with the systems and methods described herein.

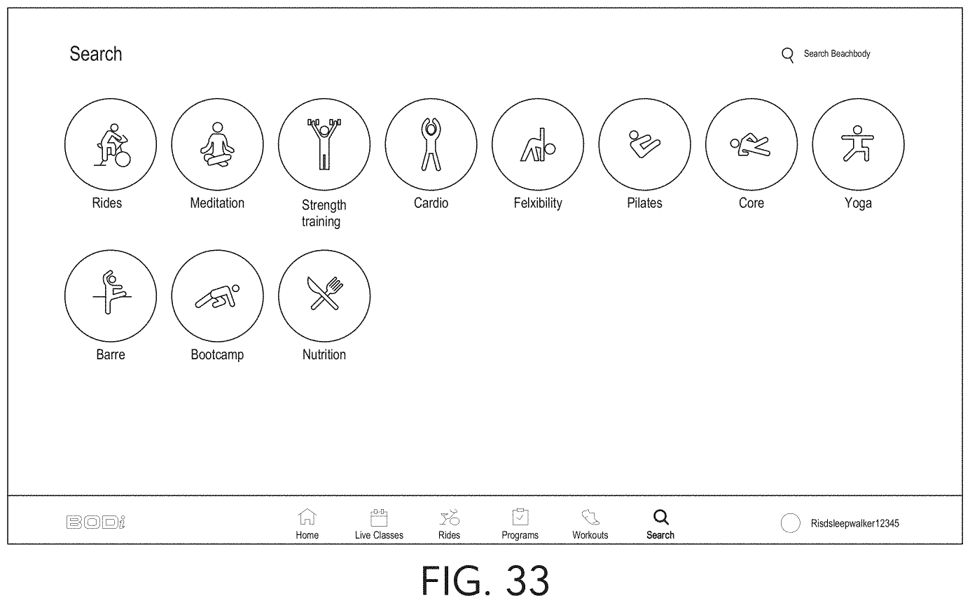

FIG. 33 is a diagram that illustrates screenshots of a process for searching for workout sessions or other informational videos on recipes, tips, etc., in accordance with the systems and methods described herein.

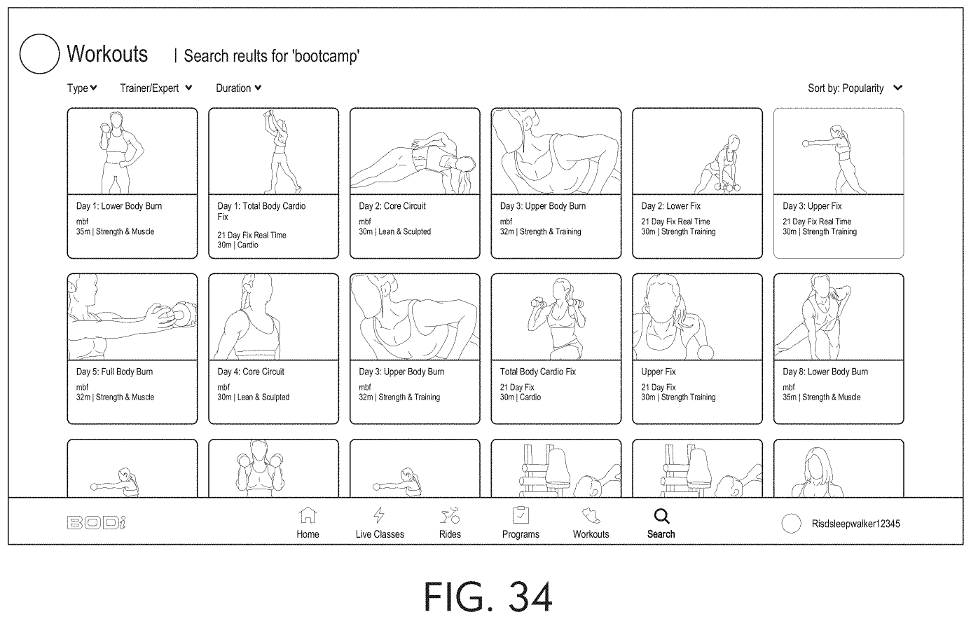

FIG. 34 is another diagram that illustrates screenshots of a process for searching for workout sessions or other informational videos on recipes, tips, etc., in accordance with the systems and methods described herein.

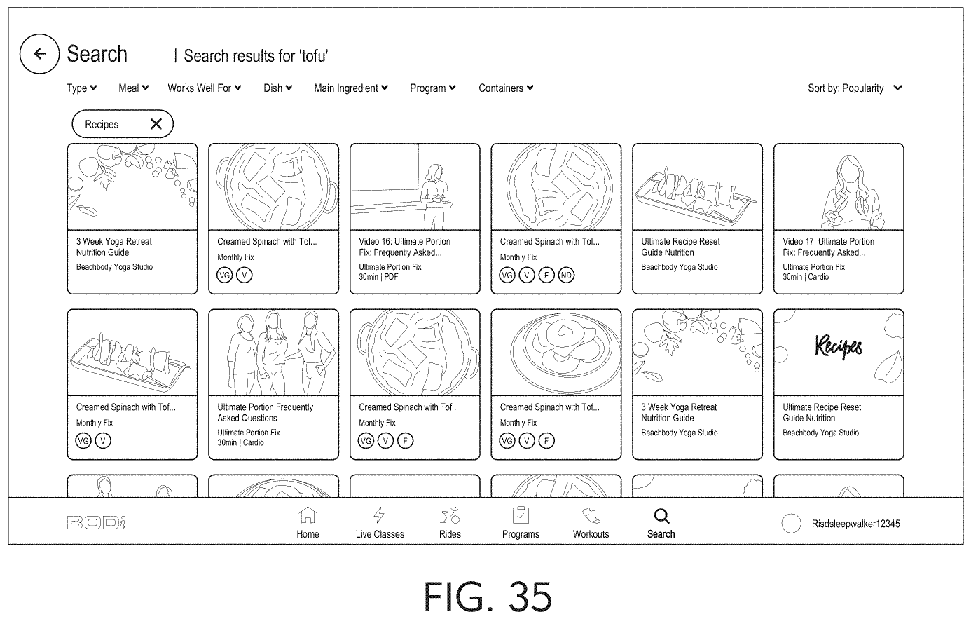

FIG. 35 is another diagram that illustrates screenshots of a process for searching for workout sessions or other informational videos on recipes, tips, etc., in accordance with the systems and methods described herein.

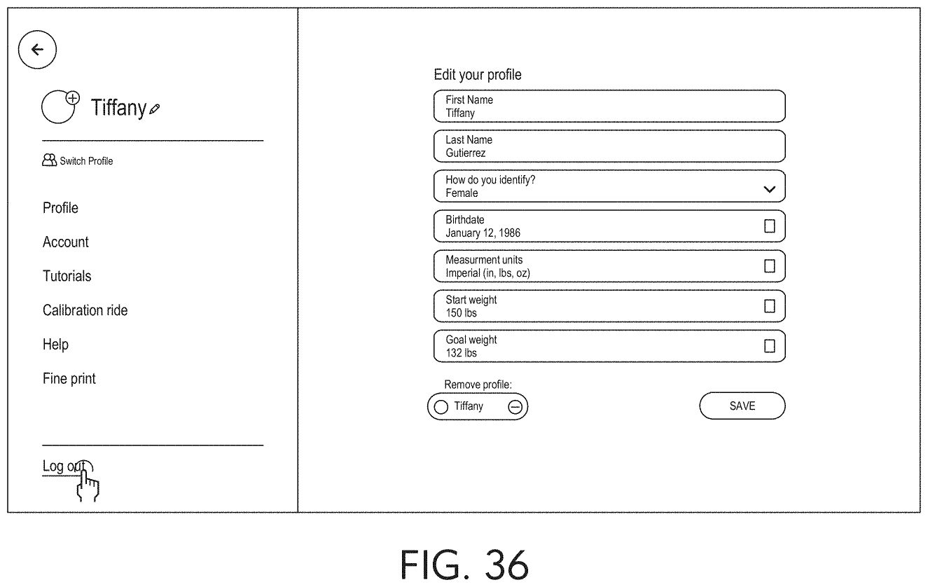

FIG. 36 is a diagram that illustrates a profile editing screen in accordance with the systems and methods described herein.

Embedded features may be implemented on one or more screens (e.g., display) of any of the above figures in accordance with the systems and methods described herein. Features may include but are not limited to, on-tablet BOD/BODi purchase, BODgroups integration in tablet, Non-workout-related tracking in tablet: (Shakeology, meal plan1 Nutritionals, water, etc.), Apple Watch pairing, e.g., with GymKit: On track with Apple's process, or without GymKit with “North Pole” may require a rework of the BOD Apple Watch application.

Embedded features that can be implemented on one or more screens (e.g., display) of any of the above figures in accordance with the systems and methods described herein. Closed captions can be provided during a live or recorded workout session in some embodiments.

Other features may include full Onlablet Purchase for BODi, integrated commerce, the ability to purchase BB products directly from the tablet, gamincation (e.g., across all platforms), favoriting, BODgroups integration, Deeper Tracking and My Progress Integration, and third Party Viewing (ex. watch Netfiixwhileyou ride)

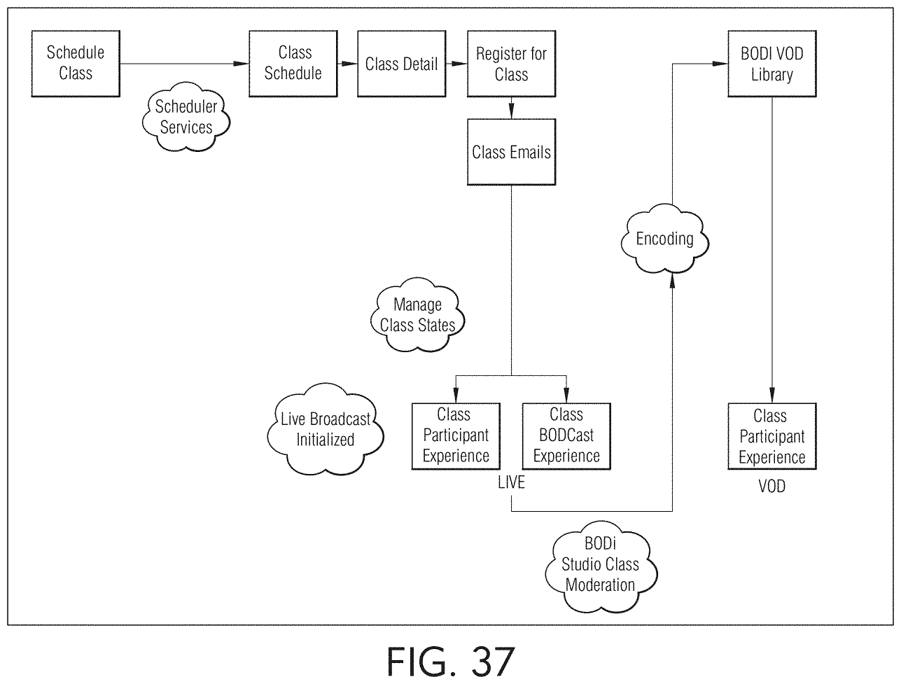

FIG. 37 is a diagram that illustrates BODi Class Flow in accordance with the systems and methods described herein. In the illustrated example, a user may schedule a class. For example, the user may schedule a class using the scheduler services and the class schedule. class details may be provided to the user such as time and place and instructor and other details that may be pertinent. After a user registers for a class they may receive various class emails. The systems and methods described herein may allow for management of class states. Live broadcasts may be initialized and provided to class participants that are registered for the class. The systems and methods described herein may provide a live exercise experience. The classes may be moderated. As a class is recorded it may be encoded and provided to a library which may allow other users to experience the class after the class as occurred.

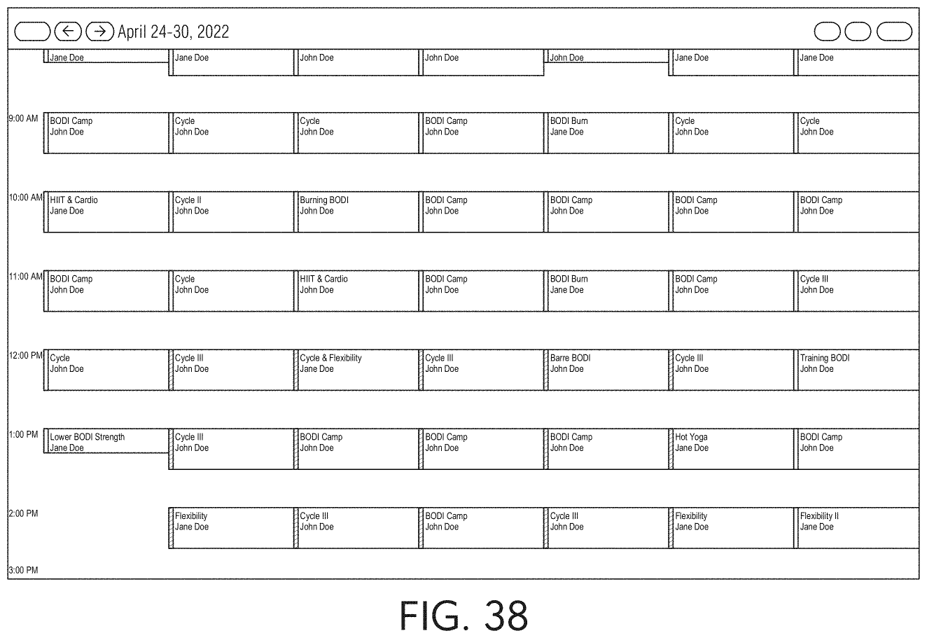

FIG. 38 is a diagram that illustrates BODi Scheduler Client in accordance with the systems and methods described herein. The figure illustrates the BODi Scheduler Client, that may be used by the production team to build the class schedule available to BODi subscribers.

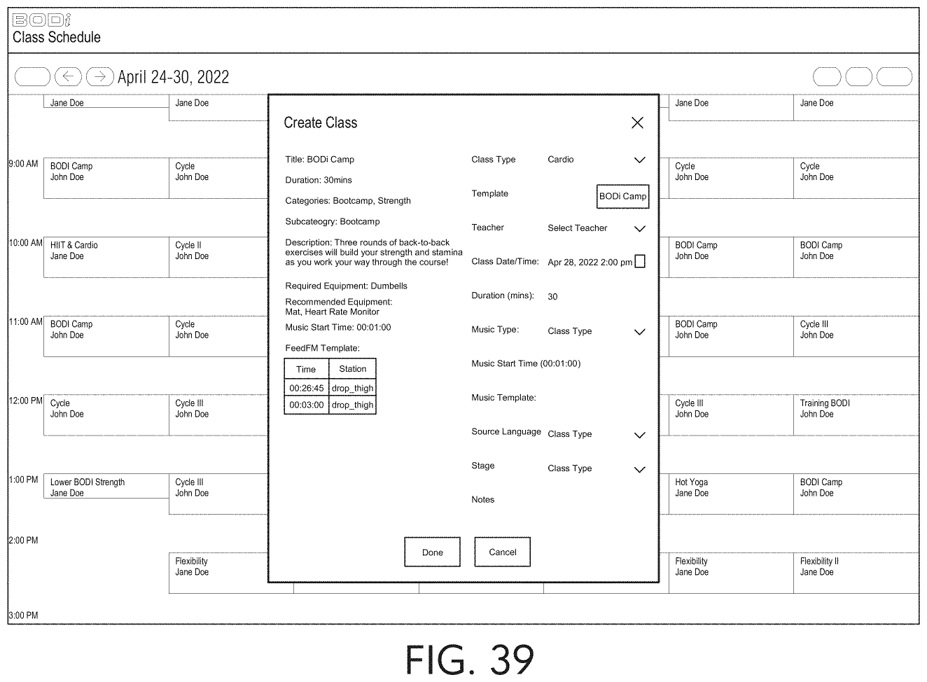

FIG. 39 is a diagram that illustrates BODi Scheduler Client, Class Creation in accordance with the systems and methods described herein. The figure illustrates the live class scheduling modal that allows the staff to customize each class.

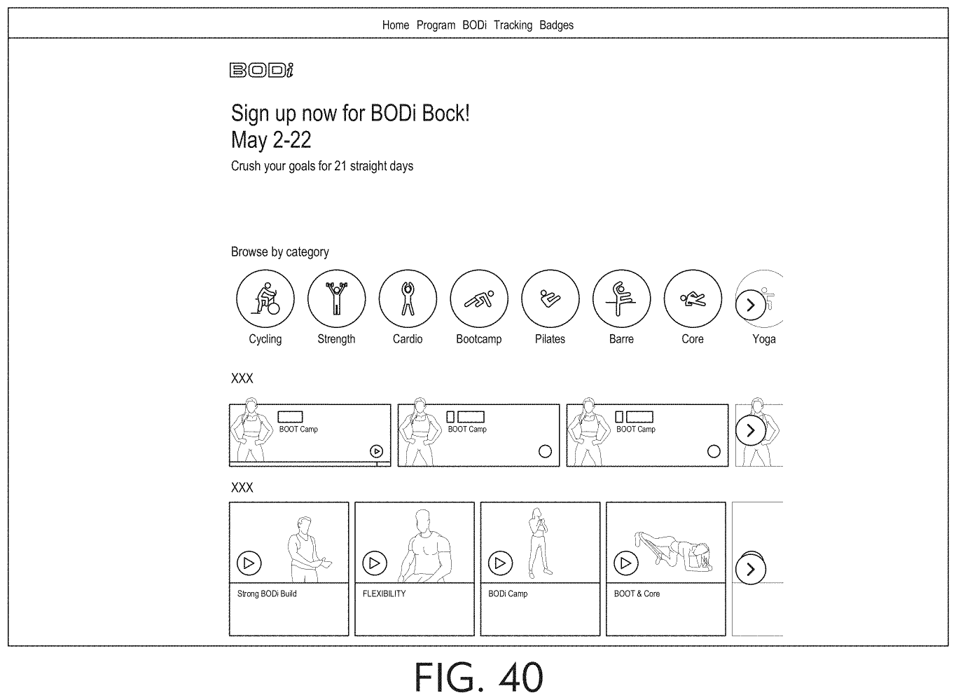

FIG. 40 is a diagram that illustrates BODi Landing Page in accordance with the systems and methods described herein. BODi subscribers can access upcoming live classes, browse previously recorded live classes, receive personalized recommendations, and access exclusive workout programs.

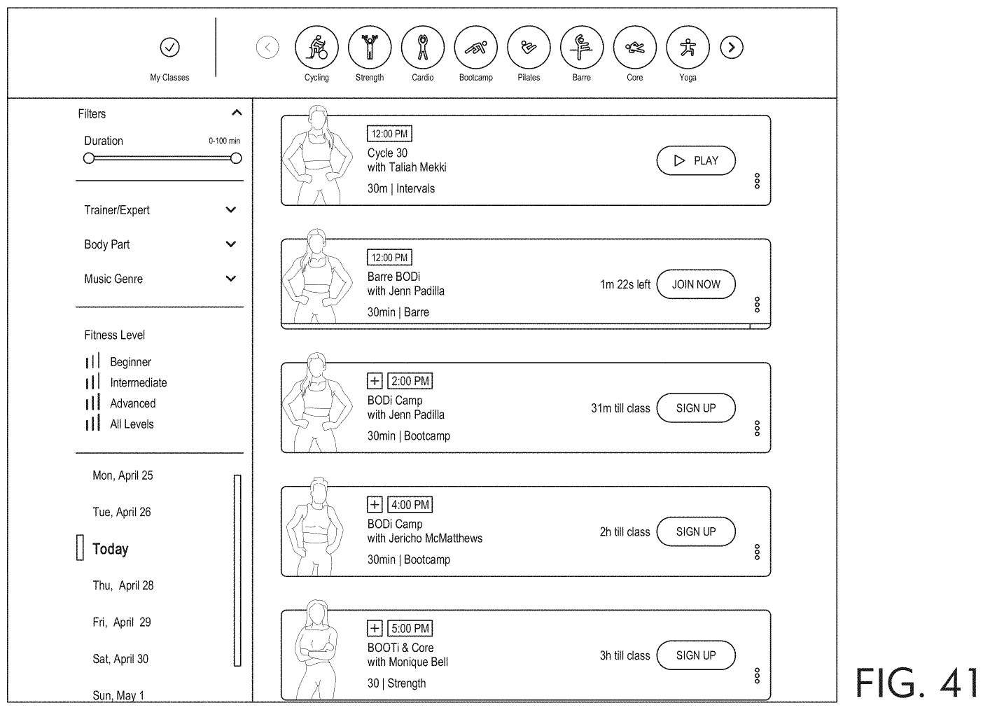

FIG. 41 is a diagram that illustrates BODi Class Schedule in accordance with the systems and methods described herein. The figure illustrates a schedule of live and replay classes that BODi subscribers can join live or register for in advance.

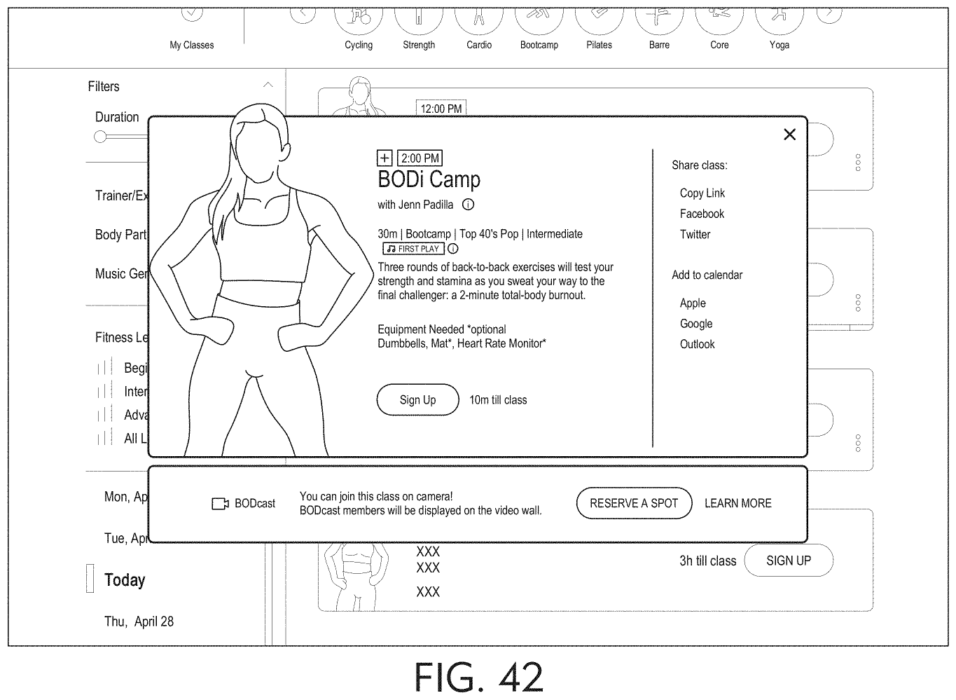

FIG. 42 is a diagram that illustrates BODi Class Detail in accordance with the systems and methods described herein. The figure illustrates the class details screen where BODi subscribers can view detailed information about the class format and trainer, as well as register for the live class or BODcast.

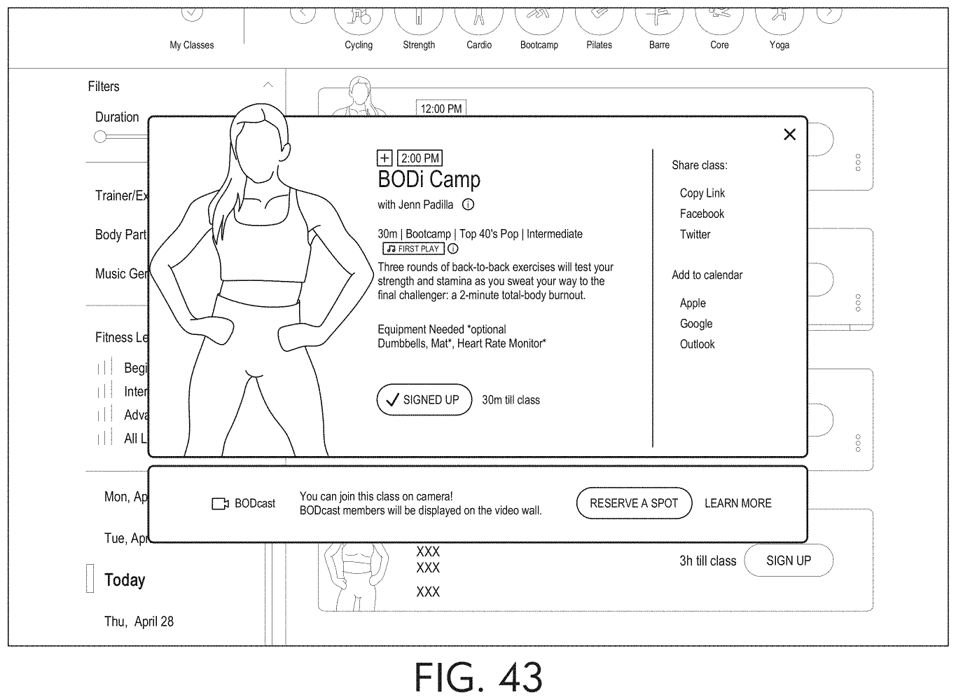

FIG. 43 is a diagram that illustrates BODi Class Detail, Registered in accordance with the systems and methods described herein. The figure illustrates the class details screen for a user that has registered for the participant experience of a BODi class.

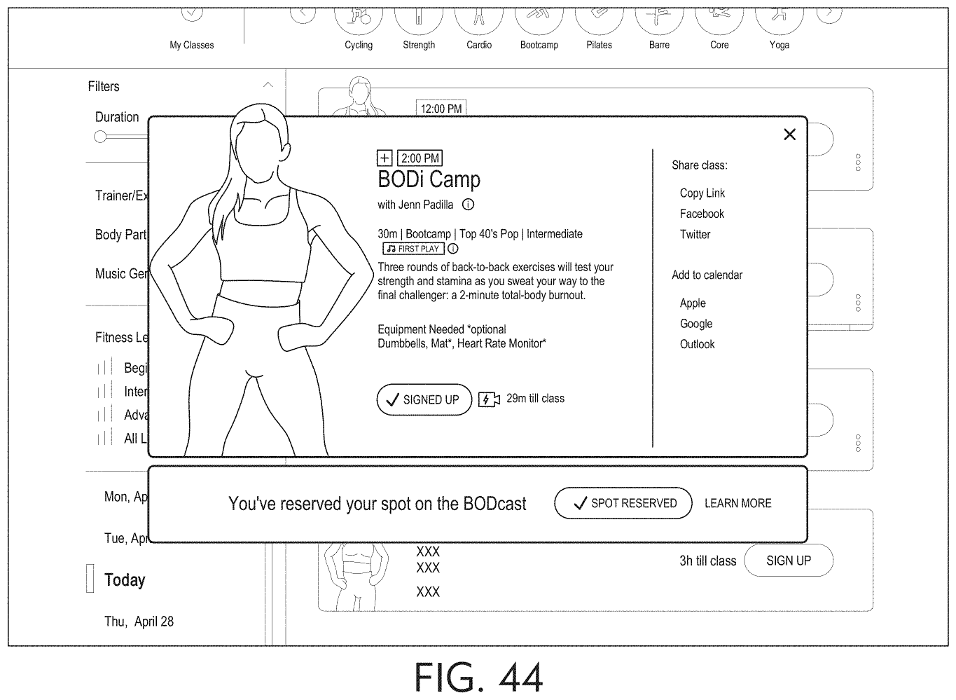

FIG. 44 is a diagram that illustrates BODi Class Detail, Registered for BODcast in accordance with the systems and methods described herein. The figure illustrates the class details screen for a user that has registered for the BODcast experience of a BODi class.

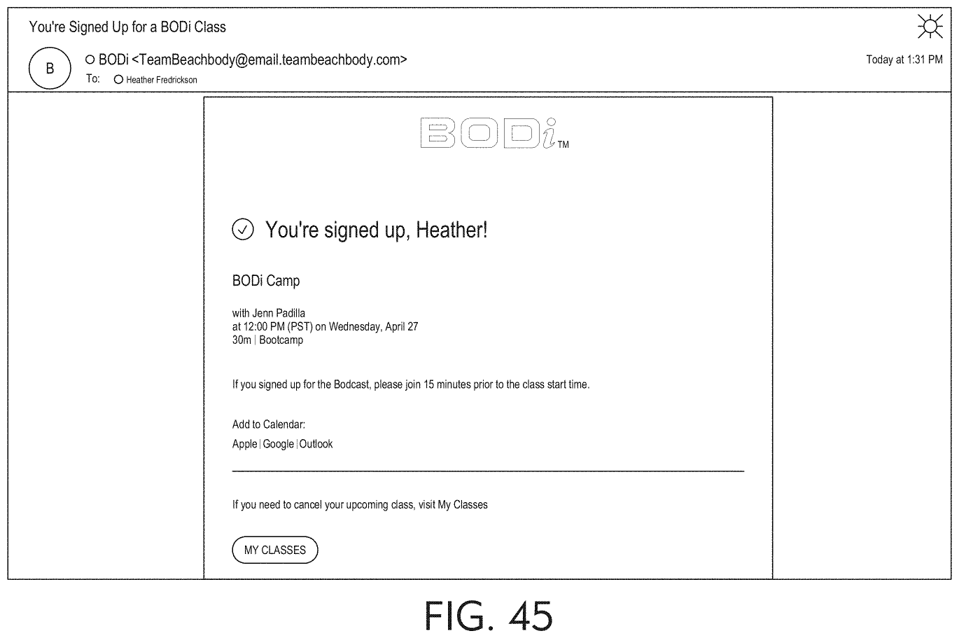

FIG. 45 is a diagram that illustrates BODi Class Registration Confirmation in accordance with the systems and methods described herein. The figure illustrates that BODi subscribers receive email notifications when registering for classes.

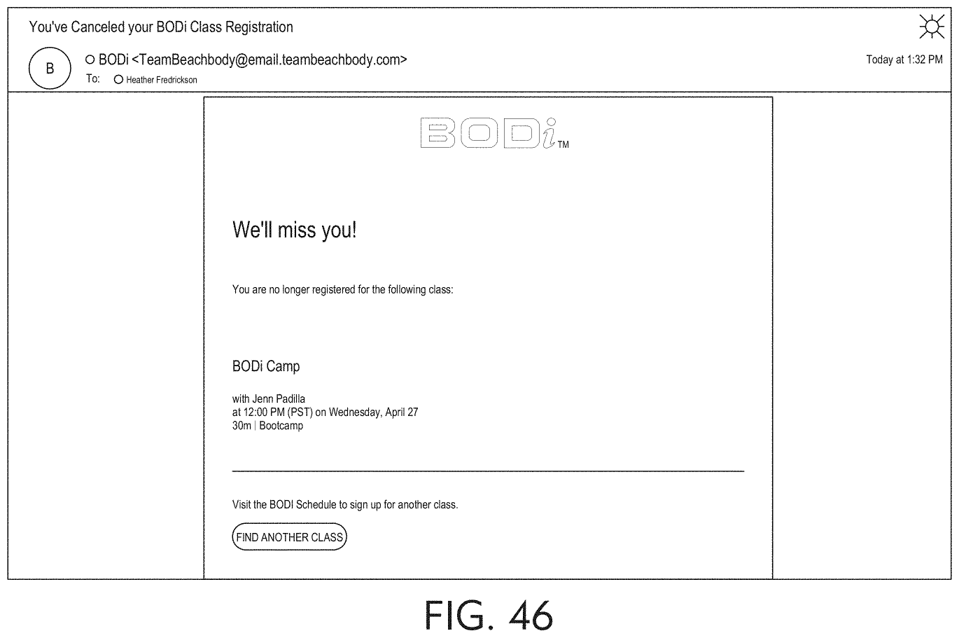

FIG. 46 is a diagram that illustrates BODi Class Cancelation Confirmation in accordance with the systems and methods described herein. The figure illustrates that BODi subscribers receive email notifications when canceling their class registration.

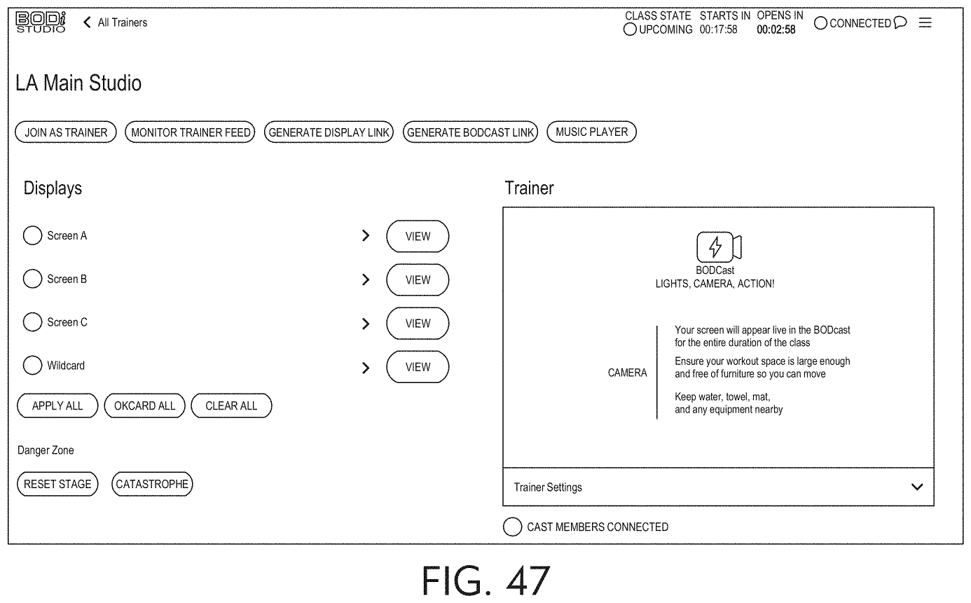

FIG. 47 is a diagram that illustrates BODi Studio Moderation Tool, Upcoming Class in accordance with the systems and methods described herein. The figure illustrates a live class in an “upcoming” state (e.g., before any users have joined the class).

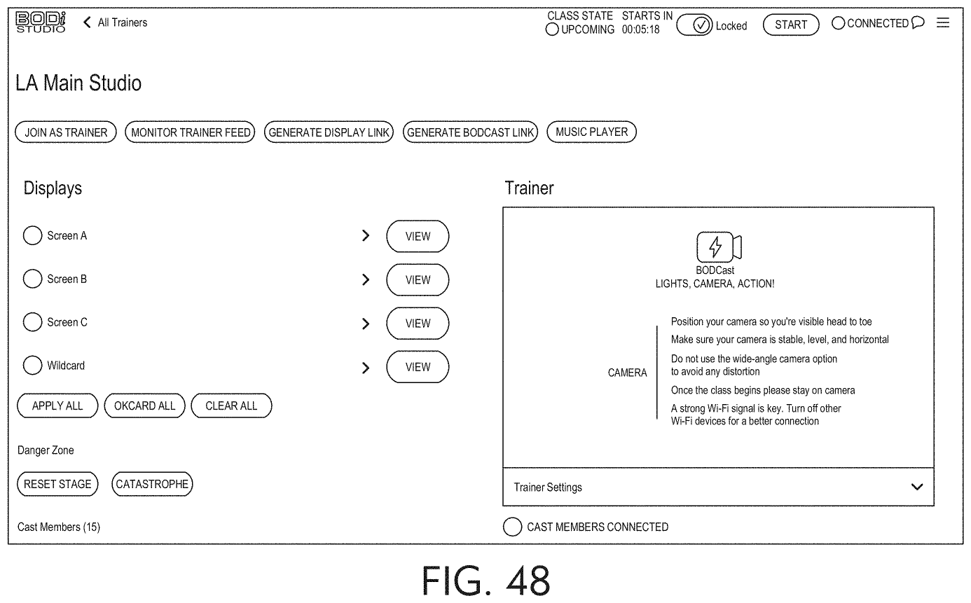

FIG. 48 is a diagram that illustrates BODi Studio Moderation Tool, Open Class in accordance with the systems and methods described herein. The figure illustrates a live class in an “open” state (e.g., users can join the class, but the workout portion has not begun).

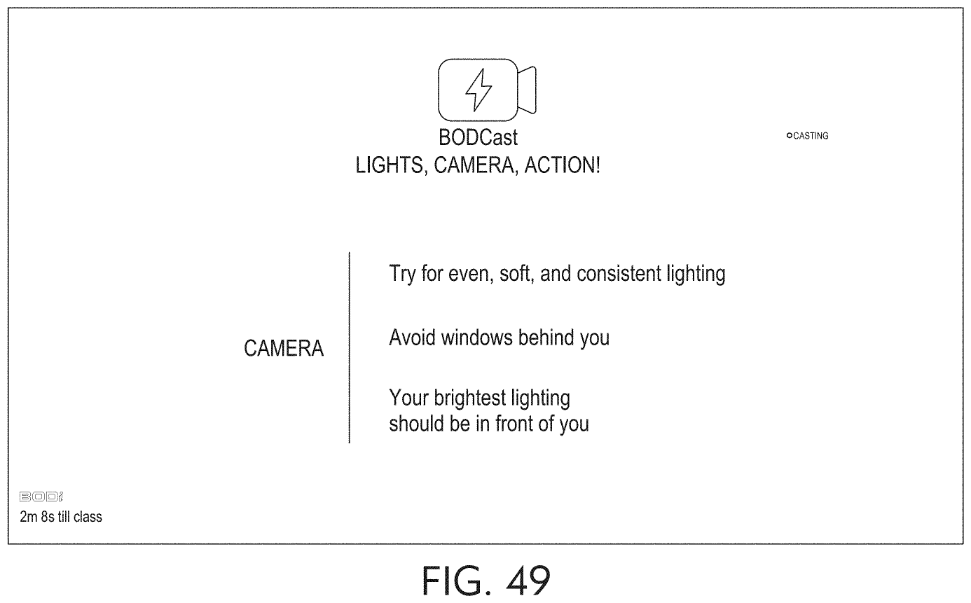

FIG. 49 is a diagram that illustrates BODcast Class Lobby in accordance with the systems and methods described herein. The figure illustrates the pre-class lobby experience for a BODcast registrant, including lighting and camera tips for having the best experience.

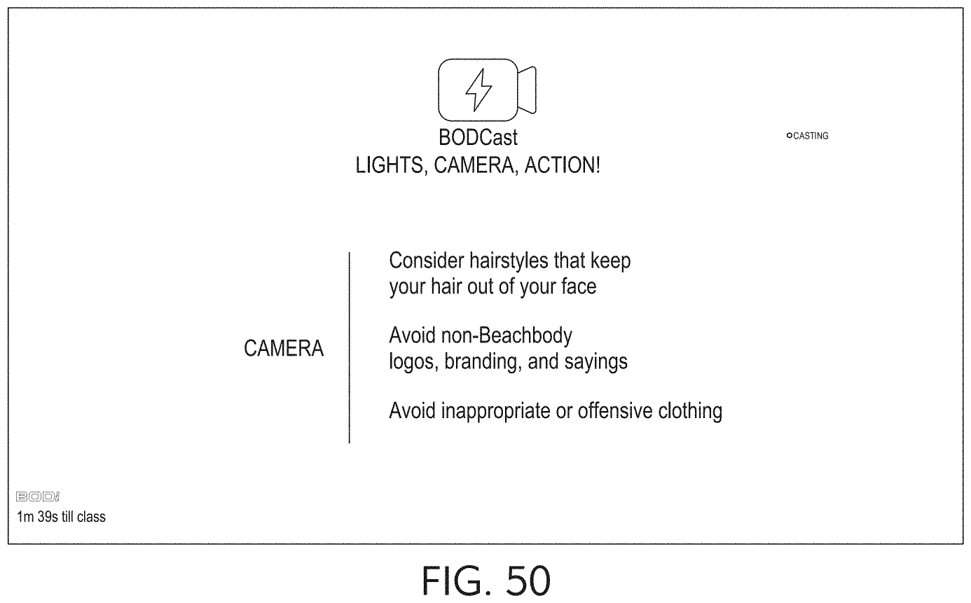

FIG. 50 is a diagram that illustrates BODcast Class Lobby 2 in accordance with the systems and methods described herein. The figure illustrates the pre-class lobby experience for a BODcast registrant, including lighting and camera tips for having the best experience.

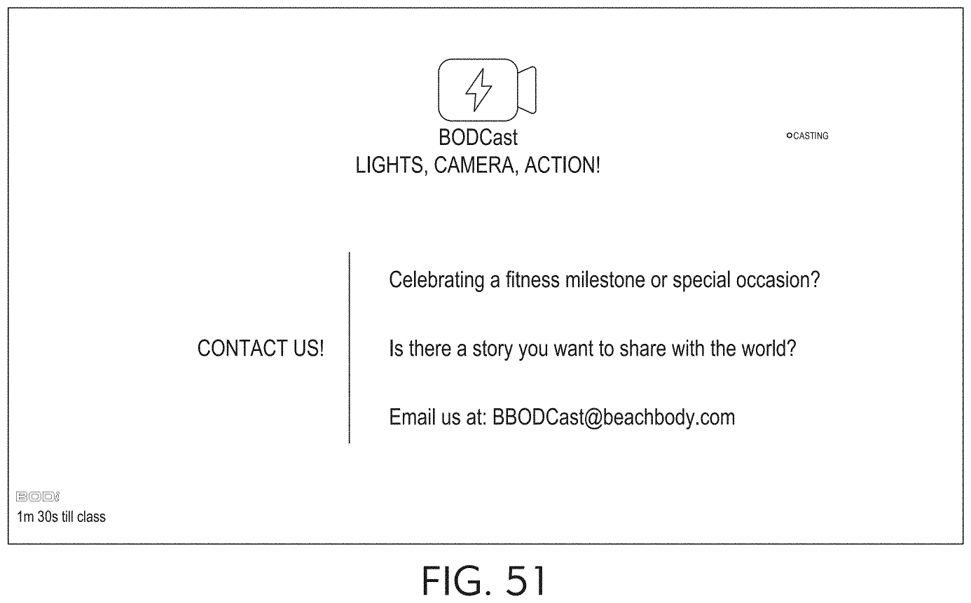

FIG. 51 is a diagram that illustrates BODcast Class Lobby 3 in accordance with the systems and methods described herein. The figure illustrates the pre-class lobby experience for a BODcast registrant, including lighting and camera tips for having the best experience.

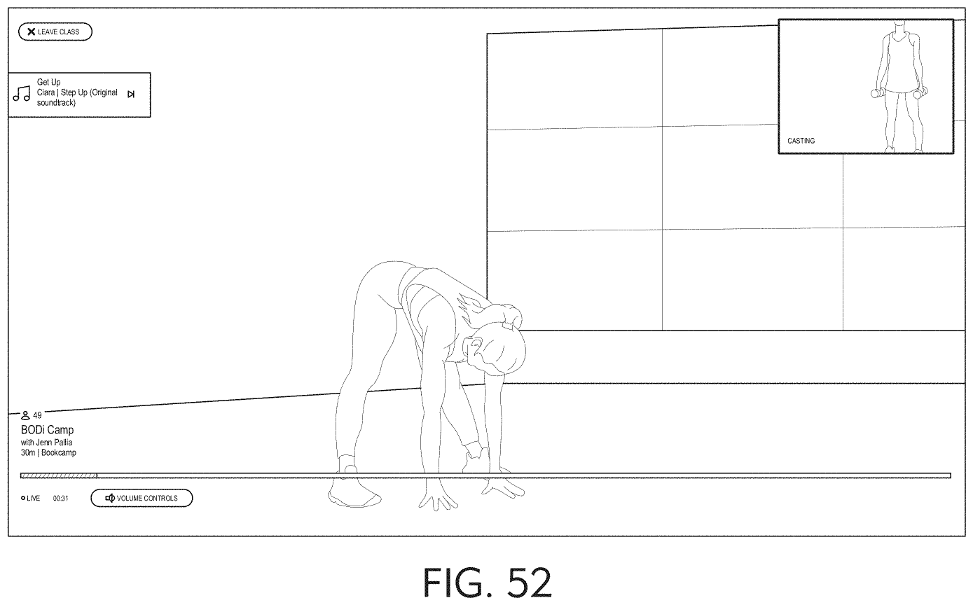

FIG. 52 is a diagram that illustrates BODi Live Class, BODcast Experience in accordance with the systems and methods described herein. The figure illustrates a live in-class experience for a BODcast user that is currently casting their video.

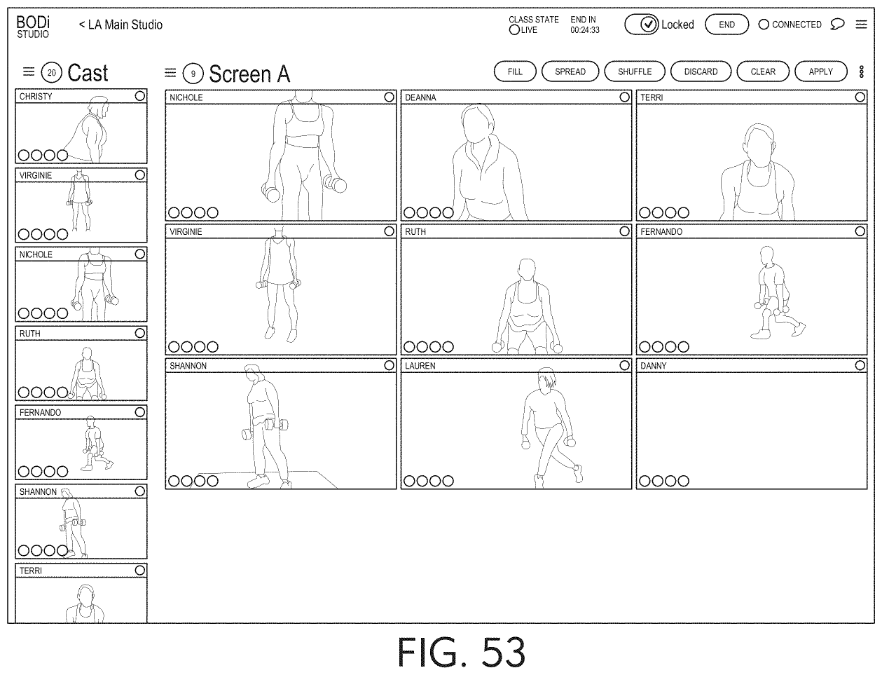

FIG. 53 is a diagram that illustrates BODi Studio Moderation Tool, Live Class in accordance with the systems and methods described herein. The figure illustrates a live class in an “live” state (e.g., the workout portion of the class is taking place, and BB producers are moderating the BODcast).

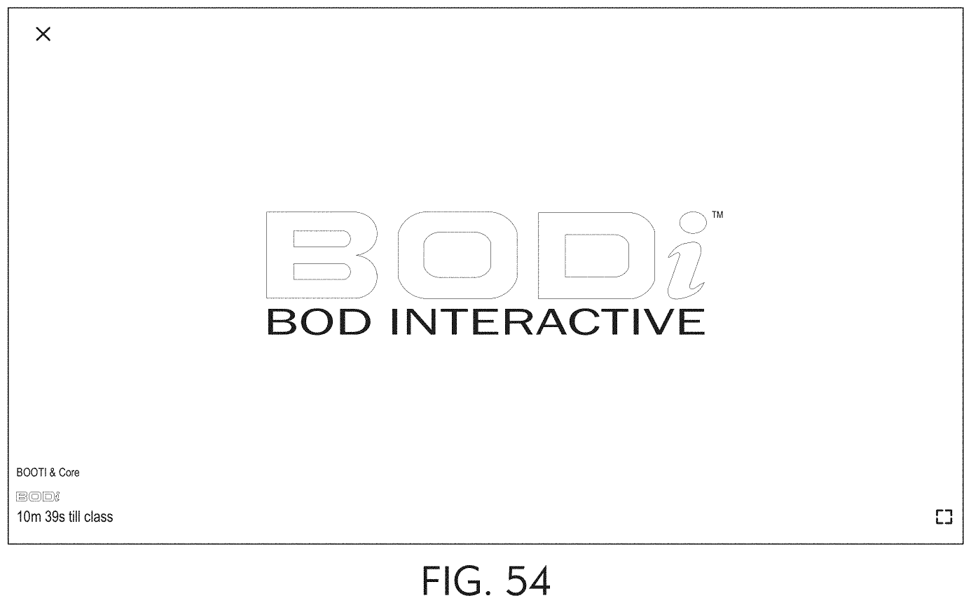

FIG. 54 is a diagram that illustrates BODi Live Class Lobby, Participant Experience in accordance with the systems and methods described herein. The figure illustrates the pre-class lobby experience for a participant registrant.

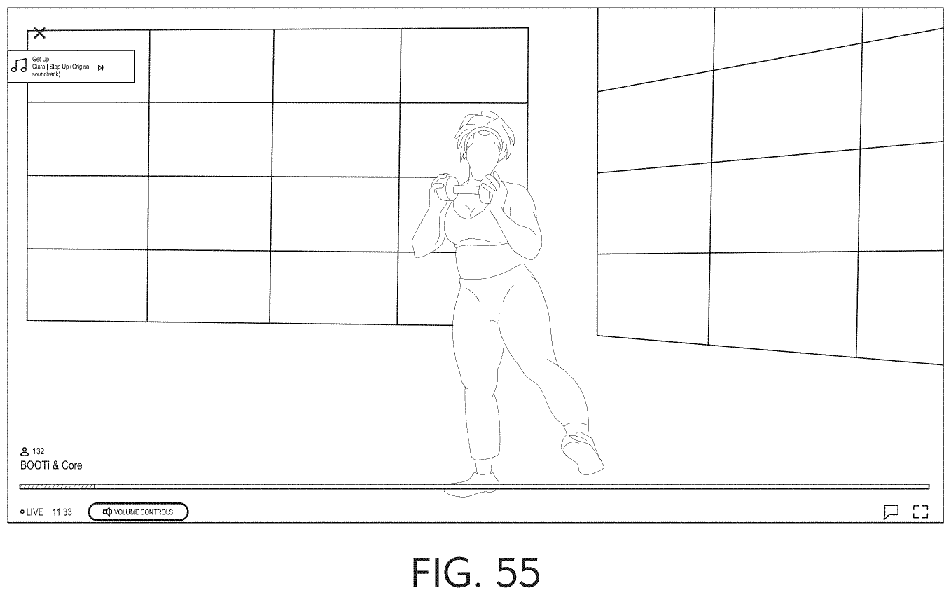

FIG. 55 is a diagram that illustrates BODi Live Class, Participant Experience in accordance with the systems and methods described herein. The figure illustrates the live in-class experience for a participant user.

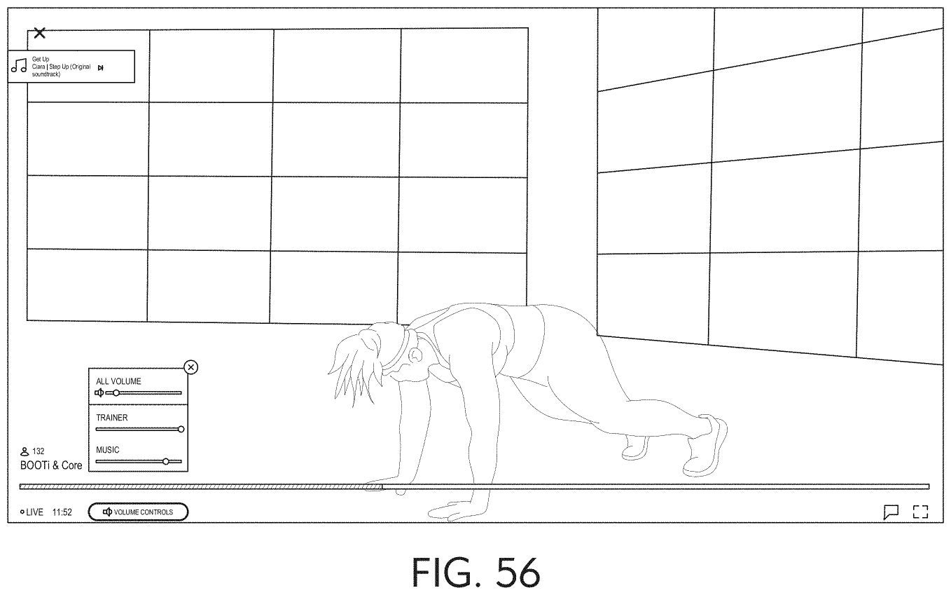

FIG. 56 is a diagram that illustrates BODi Live Class, Participant Experience 2 in accordance with the systems and methods described herein. The figure illustrates the live in-class experience for a participant user.

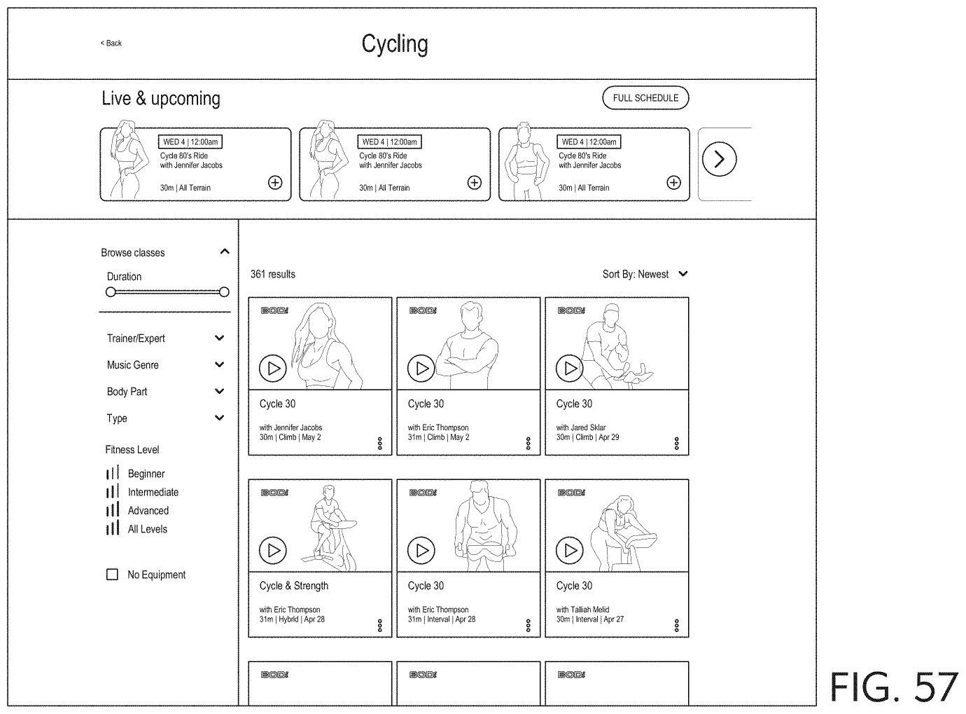

FIG. 57 is a diagram that illustrates is a diagram that illustrates BODi Video on Demand Library in accordance with the systems and methods described herein. The figure illustrates the Video on Demand Library, where BODi classes continue to exist as on-demand videos after being aired live.

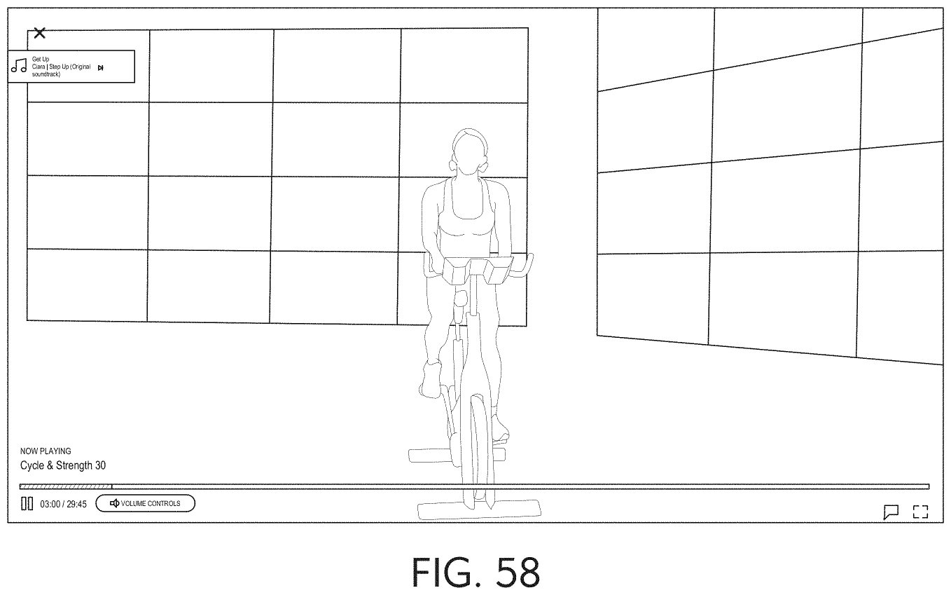

FIG. 58 is a diagram that illustrates BODi On Demand Class Experience in accordance with the systems and methods described herein. The figure illustrates the in-class experience for a BODi user viewing an on-demand class.

The embodiments described above are considered novel over the prior art. The words used in this specification to describe the instant embodiments are to be understood not only in the sense of their commonly defined meanings but to include by particular definition in this specification: structure, material, or acts beyond the scope of the commonly defined meanings. Thus, if an element can be understood in the context of this specification as including more than one meaning, then its use should be understood as being generic to all possible meanings supported by the specification and by the word or words describing the element.

The definitions of the words or drawing elements described above are meant to include not only the combination of elements that are literally set forth but all equivalent structures, materials, or acts for performing substantially the same function in substantially the same way to obtain substantially the same result. Therefore, it is contemplated that an equivalent substitution of two or more elements may be made for any of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and what incorporates the essential ideas.

In the foregoing description and the figures, like elements are identified with like reference numerals. The use of “e.g.,” “etc.” and “or” indicates non-exclusive alternatives without limitation, unless otherwise noted. The use of “including” or “includes” means “including, but not limited to,” or “includes, but not limited to,” unless otherwise noted.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the following detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method displaying a workout session, the method comprising:
determining whether a plurality of participants are eligible to be presented on a wall of live streams of a live workout session; and
displaying a video stream of a first participant from the plurality of participants on the wall of live streams based on the determination.

2. The method of claim 1, wherein the eligibility criteria comprise one or more performance metrics.

3. The method of claim 1, wherein the eligibility criteria comprise one or more previous performance metrics.

4. The method of claim 1, wherein the eligibility criteria comprise a community score of each of the plurality of participants.

5. The method of claim 1, further comprising:
monitoring the video stream of the first participant to detect inappropriate activity; and
removing the video stream of the first participant from the wall of live streams based on detection of inappropriate activity.

6. The method of claim 5, wherein monitoring to detect inappropriate activity comprises analyzing, using one or more AI-engines, the video stream of the first participant to identify and classify inappropriate attire.

7. The method of claim 5, wherein monitoring to detect inappropriate activity comprises analyzing, using one or more AI-engines, the video stream of the first participant to identify and classify inappropriate images in the background of the participant's video.

8. The method of claim 5, wherein monitoring to detect inappropriate activity comprises analyzing, using one or more AI-engines, the video stream of the first participant to identify and classify inappropriate gestures.

9. The method of claim 1, wherein the wall of live streams comprises a plurality of live streams of participants at various remote locations.

10. A system for displaying a workout session having a virtual wall of live streams, the system comprising:
one or more processors; and
a memory coupled to the one or more processors, the memory having instructions that when executed cause the one or more processor to:
determine whether a plurality of participants are eligible to be presented on a wall of live streams of a live workout session, and
display a video stream of a first participant from the plurality of participants on the wall of live streams based on the determination.

11. The system of claim 10, wherein the eligibility criteria comprise one or more performance metrics.

12. The system of claim 10, wherein the eligibility criteria comprise one or more previous performance metrics.

13. The system of claim 10, wherein the eligibility criteria comprise a community score of each of the plurality of participants.

14. The system of claim 10, wherein the instructions is further configured to cause the one or more processors to:
monitor the video stream of the first participant to detect inappropriate activity; and
remove the video stream of the first participant from the wall of live streams based on detection of inappropriate activity.

15. The system of claim 14, wherein the instruction to detect inappropriate activity comprises instructions to analyze, using one or more AI-engines, the video stream of the first participant to identify and classify inappropriate attire.

16. The system of claim 15, wherein the instruction to detect inappropriate activity comprises instructions to analyze, using one or more AI-engines, the video stream of the first participant to identify and classify inappropriate images in the background of the participant's video.

17. The system of claim 15, wherein the instruction to detect inappropriate activity comprises instructions to analyze, using one or more AI-engines, the video stream of the first participant to identify and classify inappropriate gestures.

18. The system of claim 15, wherein the wall of live streams comprises a plurality of live streams of participants at various remote locations.
